(19) United States
(12) Patent Application Publication
(10) Pub. No.: US 2013/0315604 A1
(43) Pub. Date: Nov. 28, 2013

(54) MOBILE BI-DIRECTIONAL FREE-SPACE OPTICAL NETWORK

(71) Applicants: Peter LoPresti, Tulsa, OK (US); Hazem Refai, Tulsa, OK (US)

(72) Inventors: Peter LoPresti, Tulsa, OK (US); Hazem Refai, Tulsa, OK (US)

(73) Assignee: The Board of Regents of the University of Oklahoma, Norman, OK (US)

(21) Appl. No.: 13/983,948

(22) PCT Filed: Feb. 7, 2012
(86) PCT No.: PCT/US12/24151

§ 371 Date: Aug. 6, 2013

Related U.S. Application Data
(60) Provisional application No. 61/440,234, filed on Feb. 7, 2011.

(51) Int. Cl. H04B 10/112; H04B 10/27

(52) U.S. Cl. CPC H04B 10/1129; H04B 10/271
USPC 398/116; 398/129

(57) ABSTRACT

The system provides a mobile, full bi-directional, free-space optical (FSO) network providing networkability and internet connectivity. Each mobile system has a FSO transceiver communicating via line-of-sight (LOS) with a stationary FSO transceiver. Alternatively, the mobile system communicates with a relay FSO transceiver that is in contact with another relay and/or a stationary FSO transceiver. The system has diversity of wavelengths through a multi- wavelength system operating predominately in the infrared spectrum. The network is directionally constrained by the optical components to reduce interference with other networks. Pointing, acquisition, and tracking (PAT) of the network optical signal generator and receivers assists optical performance.

### CROSS-REFERENCE TO RELATED APPLICATION

This application claims the benefit of and incorporates by reference U.S. Provisional Application No. 61/440,234 entitled MOBILE BI-DIRECTIONAL FREE-SPACE OPTICAL NETWORK filed on Feb. 7, 2011.

### BACKGROUND

Numerous electronic devices and communication networks regularly compete for a small, limited segment of the radio frequency (RF) bandwidth spectrum. The competition creates electronic clutter, which limits electronic transmission availability, time and speed. The clutter has intensified with the dramatic increase in the use of mobile and wireless devices by individuals and business personnel. Demand for service has risen sharply and steadily due to phone and internet traffic created by network users desiring to read email, access the internet/web, download/upload videos, send/receive files, conduct video teleconferencing, perform electronic monitoring, and a host of other wireless-based activities. Accordingly, the RF spectrum is increasingly unavailable for currently existing devices and systems. Amplifying this problem is that the RF spectrum is severely restricted from accepting the addition of new or emerging wireless devices and systems. Thus, there is a need for a viable alternative to the mobile and wireless systems using the RF spectrum.

One solution is to create free-space optical (FSO) networks. FSO networks are optically-based, and have high bandwidth, bi-directional transmission capabilities producing both short bursts and longer transmission periods. Typically, FSO networks use lasers to communicate. Current state-of-the-art FSO networks are limited by being fixed in-place networks.

Another problem with existing FSO networks and systems is the requirement to have a narrow or tight line-of-sight (LOS) tolerance between each node. Any significant angle or deviation from the very tight LOS tolerance disrupts and/or terminates the FSO connectivity. To avoid deviations from the tight LOS tolerance, most FSO nodes are mounted on large structures such as buildings, or other relatively stable platforms. Therefore, the size, weight and power requirements for the node design are not overly restrictive. Accordingly, existing FSO systems and networks are too heavy and too cumbersome to be a fully mobile alternative.

Another limiting factor for current FSO networks is that most FSO node installations begin with a gross static alignment that is easily refined during the initial setup of the equipment. For those cases where gross pointing for tracking purposes is required, larger optics and gimbals are utilized, without any concern regarding the weight penalties on the mounting location. Distance-related propagation losses can be overcome with larger input power at the node, which means larger equipment and more powerful lasers at each node. These factors work against mobility of the FSO system.

Another problem of current FSO networks and systems face is the adverse impact from weather conditions such as fog, rain, snow, thermal turbulence and atmospheric turbulence. Even though the true optical path between the nodes remains intact, weather conditions cause a partial or complete disruption of the optical communications link, including the optical communications link suffering from signal fade and/or dropping the signal. Current FSO networks and systems overcome fading due to weather-related propagation losses by using larger input power at the node. However, without an alternate path for the optical signal to communicate between the nodes, recovery of the signal during the weather event is not available. An additional concern with increased input power is the potential for creating an eye-unsafe environment within the line-of-sight of the laser.

Mobility of an FSO system requires off-axis communications between nodes, and a less-than-perfect LOS therebetween. As such, existing FSO solutions cannot provide fully mobile, bi-directional, FSO networks that are capable of providing networkability and internet connectivity.

Because a mobile FSO system must be lightweight, it cannot readily provide increased power or gimbaled systems when attempting to overcome channel fading due to weather or turbulence.

Another problem for mobile FSO systems relates to pointing, acquisition, and tracking (PAT) between nodes. PAT is required to maintain communication between nodes in the mobile environment. The existing FSO systems may have a gimbaled system, but the gimbal does not allow acquisition and tracking functions between nodes. Additionally, existing FSO systems are intolerant of misalignments and incapable of working with multiple simultaneous transmissions.

A mobile, bi-directional, FSO system having a high bandwidth for bi-directional transmission, including off-axis communications is needed. A system having capability for the FSO system to operate in both short bursts and over long periods to deliver high resolution imagery, high quality video streams and/or internet applications is also needed. Higher bandwidth will also provide improved communications between ground nodes, airborne nodes, and combinations thereof.

### SUMMARY

In accordance with the present invention, a method for creating a free-space optical network overcoming the deficiencies described above, and having other advantages, is provided.

In one aspect, a free-space optical network is provided. The free-space optical network comprises a network having a plurality of nodes, at least one access node, at least one origination node, and a control system. The access node includes a first transceiver capable of multi-angle, bi-directional line-of-sight optical communications, wherein the access node is in bi-directional electronic communication with the network. At least one origination node includes a second transceiver, wherein the origination node is positioned within a line-of-sight of the access node. The origination node provides network connectivity for at least one end-user. The control system is adapted to maintain line-of-sight optical communications between the access node and the origination node.

In another aspect, a mobile free-space optical network is provided. The mobile free-space optical network comprises a network having a plurality of nodes, at least one access node, at least one mobile origination node, a control system, and a pointing, acquisition and tracking system. The access node includes a first transceiver capable of multi-angle, bi-directional line-of-sight optical communications, wherein the access node is in bi-directional electronic communication with the network. The mobile origination node includes a second transceiver, wherein the mobile origination node is positioned within the line-of-sight of at least one access node. The control system is configured to maintain line-of-sight optical communications between the access node and the mobile origination node. The pointing, acquisition and tracking system is electronically controlled by the control system, and capable of detecting a beacon signal from the transceiver, initiate and then reorient the transceiver to maximize optical communication between transceivers and to maintain the line-of-sight therebetween.

In another aspect, the current invention provides a method of operating a mobile free-space optical network. The method comprises the steps of: providing an access node, the access node adapted to bi-directionally send and receive optical communications, wherein the access node is in electronic communication with a network; providing a mobile origination node, the mobile origination node configured to bi-directionally send and receive optical communications with at least one access node; and controlling an optical communication between the access node and the mobile node using a control system, wherein the access node and the mobile origination node each have a control system therein.

### BRIEF DESCRIPTION OF THE DRAWINGS

FIG. 1 is a schematic overview of the free-space optical network.

FIG. 2 is a schematic of the free-space optical network having two access transceiver nodes in communication with a mobile origination node.

FIG. 3 is a schematic of a transceiver.

FIG. 4 is a schematic of a transmitter.

FIG. 5 is a schematic of a receiver.

FIG. 6 is a schematic of optical communication with a receiver.

FIG. 7 is a schematic of a converging lens directing the optical communication to one or more optical fibers in a fiber optic bundle.

FIG. 8 is a schematic of an array of converging lens directing multiple optical communications to optical fibers in a fiber optic bundle.

FIG. 9 is a schematic illustrating one processing technique of the optical processor.

FIG. 10 is a schematic illustrating another processing technique of the optical processor.

FIG. 11 is a schematic illustrating multiple end-users simultaneously communicating with an optical access point using a time division multiple access.

FIG. 12 is a detail view of the receiving optic.

FIG. 13 is a schematic illustrating the use a satellite for optically communicating between two locations not having a direct line-of-sight.

FIG. 14 is a schematic illustrating a broadcast message.

FIG. 15 is a graph of the maximum likelihood (ML) detection threshold values for varying fading intensities.

FIG. 16 is a block diagram of an algorithm depicting a third protocol utilized by the channel estimation system to dynamically update the threshold using the obtained channel state information (CSI), thus achieving optimal detection of on/off keying (OOK) modulation with direct detection in turbulence fading channels.

FIG. 17 is a graph of the bit error rate (BER) against an average signal-to-noise ratio (SNR) illustrating a FSO network link BER using multi-slot averaging (MSA) in a lognormal channel

FIGS. 18a and 18b depict a first protocol defining the alignment and re-alignment of the transceiver.

FIG. 19 is a schematic illustrating the decision process from step 404 in FIG. 18a when the switch network is composed of only power splitters

FIG. 20 depicts the decision process from step 404 in FIG. 18a when the switch network is composed of only optical switches

FIG. 21 depicts the decision process from step 404 in FIG. 18a when the switch network is composed of a combination of power splitters and switches.

FIG. 22 illustrates a node transmitting a signal to a target area having a mobile origination node within.

FIG. 23 depicts one embodiment of a switch network utilizing optical splitters.

FIG. 24 depicts one embodiment of a switch network utilizing optical switches.

FIG. 25 depicts one embodiment of a switch network utilizing optical splitters and optical switches.

### DETAILED DESCRIPTION

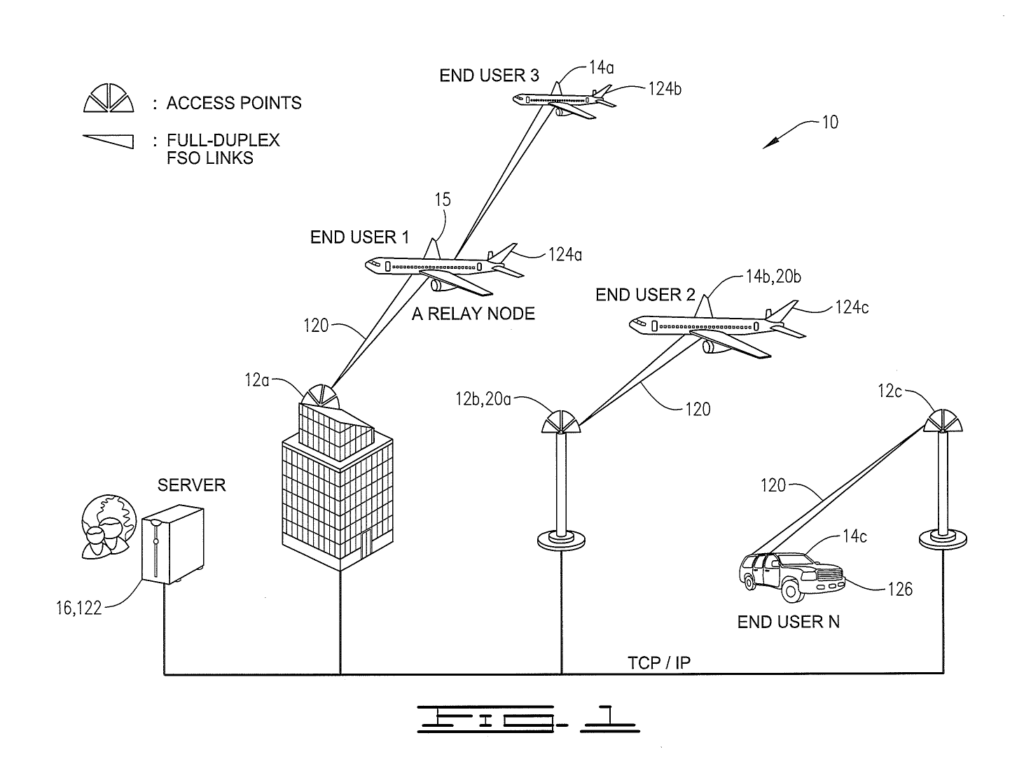

Referring to FIG. 1, the inventive mobile free-space optical (FSO) communications network is illustrated and generally designated by the numeral 10, and referred to hereinafter as FSO network 10. As shown by the drawings and understood by those skilled in the art, FSO network 10 includes three different types of optical nodes: access nodes 12, origination nodes 14 for end-users, and relay nodes 15. FSO network 10 includes at least one access node 12 and at least one origination node 14. In some embodiments, FSO network 10 includes relay node 15, which is an intermediary node, between access nodes 12 and origination nodes 14.

Each node type has different operating capabilities. Access nodes 12 having a transceiver are capable of capturing multiple optical signals simultaneously and bi-directionally communicate information back to each originating node 14. Relay nodes 15 are capable of connecting with at least two other, spatially distant nodes having very different transceiver orientations. Origination nodes 14 bi-directionally communicate in a point-to-point link with at least one other node. Operating under adverse conditions, including weather, all node types are capable of multi-wavelength operation to maintain performance. Additionally, access node 12, origination node 14, and/or relay node 15 may also include the ability to communicate with known reference points such as the global positioning system (GPS) to obtain exact location information.

Access node 12 is physically connected to network 16, and defines the point of entry into network 16 for electronic communications. As used herein, electronic communications is used interchangeably with electrical communications. Access node 12 provides for the receipt and transmission of optical communications. Access node 12 converts the optical communication into an electrical communication for network 16 when receiving an optical communication, and converts the electrical communication from network 16 into an optical communication.

Referring to FIGS. 1-6 and 11, access node 12, origination node 14, and relay node 15 each have at least one transceiver 20. Transceiver 20 is capable of multiple-angle, bi-directional line-of-sight optical communications with another transceiver 20, and defines the communications between transmitter 22 and receiver 24 between nodes. In one embodiment, transceiver 20 is secured by a motorized mount (not shown) and is in electronic communication with processing and control module 28. The motorized mount provides for manual or automatic alignment adjustment when the angle between nodes is too great.

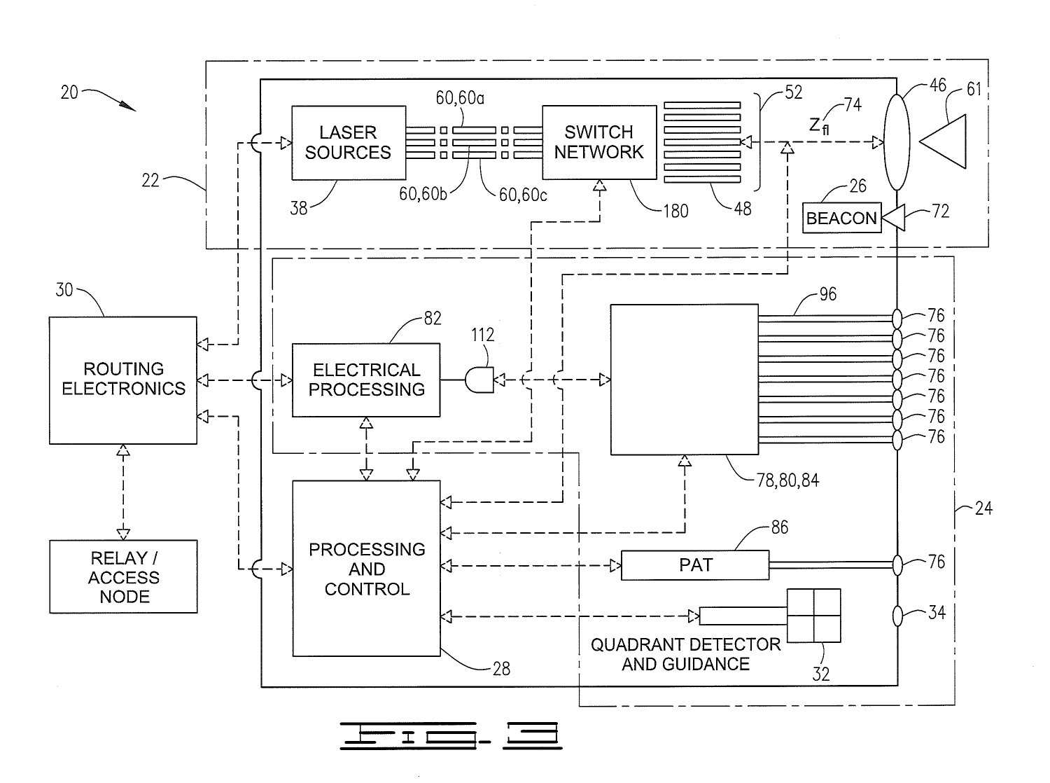

Referring to FIG. 3, transceiver 20 includes at least one transmitter 22, at least one receiver 24, and at least one beacon 26. Preferably, beacon 26 is associated with transmitter 22. Preferably, transceiver 20 includes a plurality of nodes having at least one transmitter 22, a plurality of receivers 24, and processing and control module 28 that is in electronic communication with routing electronics 30. Preferably, transceiver 20 also includes quadrant detector 32 in optical communication with detection lens 34. Quadrant detector 32 is in electronic communication with processing and control module 28. The optical input of quadrant detector 32 is used to optically align and correct transceiver 20 with another transceiver 20. Preferably, relay node 15 carries at least two transceivers 20.

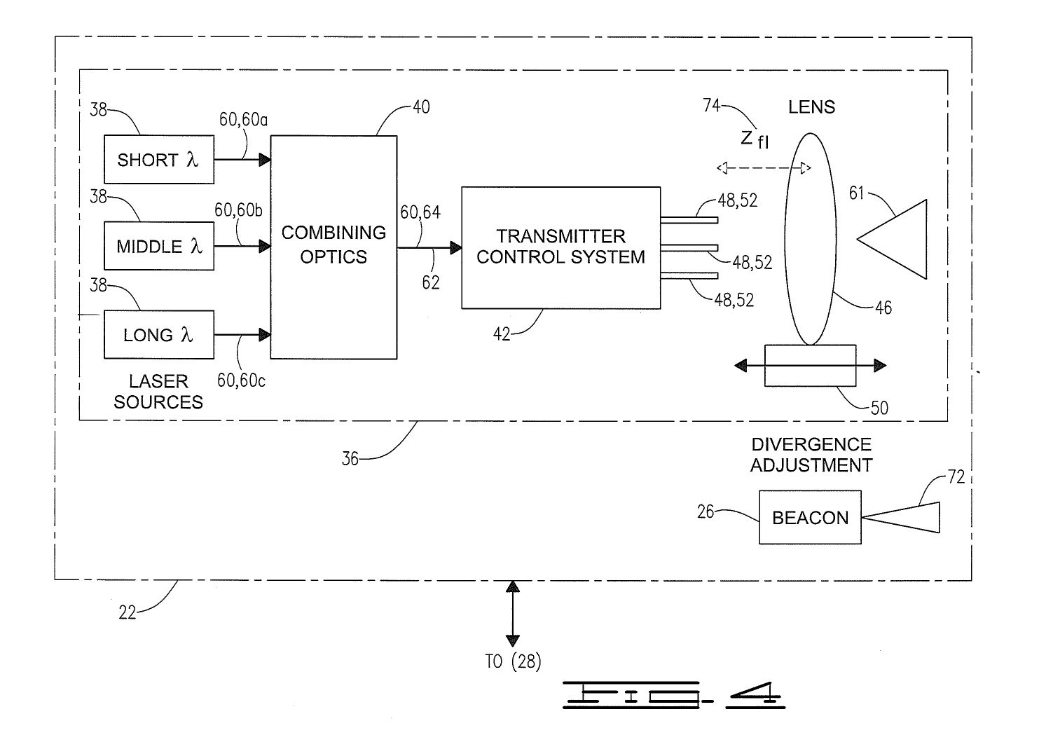

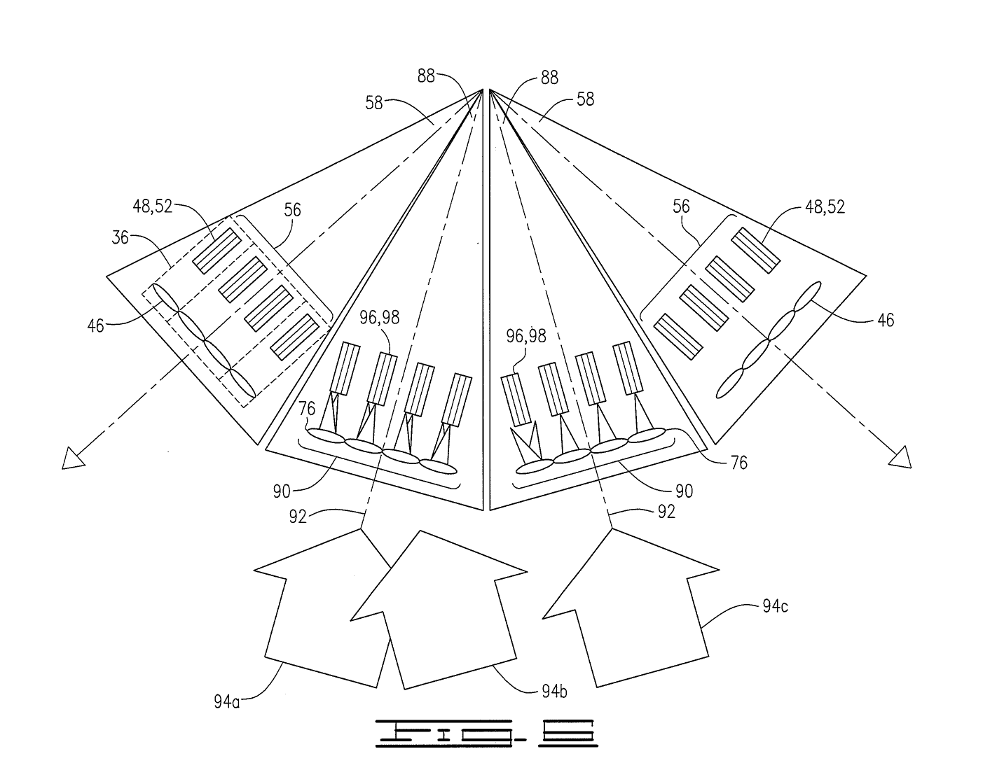

As shown in FIGS. 4 and 6, each transmitter 22 has at least one transmitter sub-unit 36. Transmitter sub-unit 36 includes at least one laser source 38, combining optics 40, transmitter control system 42, control interface (not shown) control interface is within processing and control module 28, at least one lens 46, also referred to as transmit lens, in optical communication with a plurality of transmit fiber optic cables 48, and divergence adjuster 50. Transmit fiber optic cables 48 are positioned within fiber bundle 52. Laser source 38 is a transmitting laser used to provide optical communications.

Still referring to FIGS. 4 and 6, in one embodiment, transmitter 22 has a plurality of transmitter sub-units 36 defining transmitter sub-unit array 56. Each transmitter 22 defines the out-going optical communication 61 between network 16 and mobile users connected thereto, or between network 16 and to relay node 15. Transmitter 22, working with receiver 24, beacon 26, quadrant detector 32, and the associated electronics defined below, provides for tracking between the mobile user's origination node 14, access node 12 and/or relay node 15. Based upon optical feedback from quadrant detector 32 and beacon 26, the electronics associated with transmitter 22 adapt to shift between a particular laser source 38 and transmit fiber optic cable 48 to maximize the optical signal propagating through access cone 58 of the particular transmitter sub-unit 36. Optical feedback from quadrant detector 32 includes data that is known to those having skill in the relevant art. Access cone 58 includes a plurality of transmit fiber optic cables 48 in optical communication with lens 46, and contained within transmitter sub-unit 36.

Laser source 38 preferably has a plurality of wavelengths 60. By way of a non-limiting example, wavelengths 60 are illustrated in FIGS. 3 and 4 as wavelengths 60a, 60b and 60c. Wavelengths 60a, 60b and 60c are within the electromagnetic spectrum, and preferably within the infrared (IR) spectrum, and have wavelengths between 700 nanometers (nm) and 1000 micrometers (microns).

The non-limiting example discussed below uses different wavelengths for different environmental conditions. In this non-limiting example, wavelength 60a is within the IR/near-IR range of about 700 nm to about 1310 nm, with a preferred wavelength of about 850 nm. Wavelength 60b is within the IR/near-IR to short-wavelength IR range of about 1310 nm to about 1550 nm. Wavelength 60c is short-wavelength IR to the far-IR range of about 1550 nm to about 1000 microns, with a preferred wavelength range of about 2 microns to about 10.6 microns.

Beacon 26, as shown in FIGS. 3 and 4, propagates beam 72 and provides an optical signal from transmitter 22 to receiver 24. Beacon 26 functions as a guide beacon. Preferably beacon 26 is a laser defining the initial optical communications link between origination node 14 and access node 12. Beacon 26 propagates beam 72 from a separate source (not shown), wherein beam 72 has a separate wavelength from 61 as optical input to quadrant detector 32. In another embodiment, out-going optical communication 61 is also used for “beacon” purposes. In this embodiment, beam 72 is part of wavelength 60a, 60b and/or 60c (from laser source 38). In this embodiment beams 61 and 72 are the same and beacon 26 is included within laser sources 38.

For clarity, if beacon beam 72 is from the same source as signal 61, then laser source 38 is beacon 26 and PAT 86 of the receiver will receive the optical communications. If beacon beam 72 is propagated from a separate source than signal 61, e.g. beacon 26, then optical input will be received by quadrant detector 32 of the receiver. In most circumstances it will be preferred that beams 72 and 61 are from the same source. As should be appreciated by those skilled in the art, these two embodiments are not mutually exclusive, both PAT system 86 and quadrant detector 32 may be used during operation of the FSO network, for example, for purposes of redundancy in the event of equipment failure.

As illustrated in FIG. 4, switch network 180 includes combining optics 40 and transmitter control system 42. Combining optics 40 is in optical communication with laser 38, and combines two or more laser sources 38 to propagate wavelength 60. Combining optics 40 defines a wavelength multiplexing process. Multiple multiplexing processes and techniques for combining optics 40 are known to those skilled in the relevant art and will not be discussed. The diversity of wavelength 60 provides for the selection of the optimum wavelength 60 for the current atmospheric conditions. Determination of the optimum wavelength 60 for a given atmospheric condition is known to one having skill in the relevant art. For example, the channel estimation system and a local weather monitoring system (not depicted, preferably co-located with the transmitter) determine the atmospheric conditions (specifically turbulence, regardless of its source, precipitation, if any, temperature, and wind speed and direction). If the turbulence characteristics and weather are known, there are sufficient studies available to a person having skill in the art to determine the choice of wavelength, e.g. longer wavelengths for high turbulence, shorter wavelengths for lower turbulence, and the consideration that some wavelengths are more suitable in fog or rain than others. Three representative wavelengths 60a-60c, illustrated in FIG. 4, are multiplexed onto a single fiber optic cable 62 as multiplexed optical signal 64. Combining optics 40 are in optical communication with transmitter control system 42 and multiplexed optical signal 64 is delivered thereto.

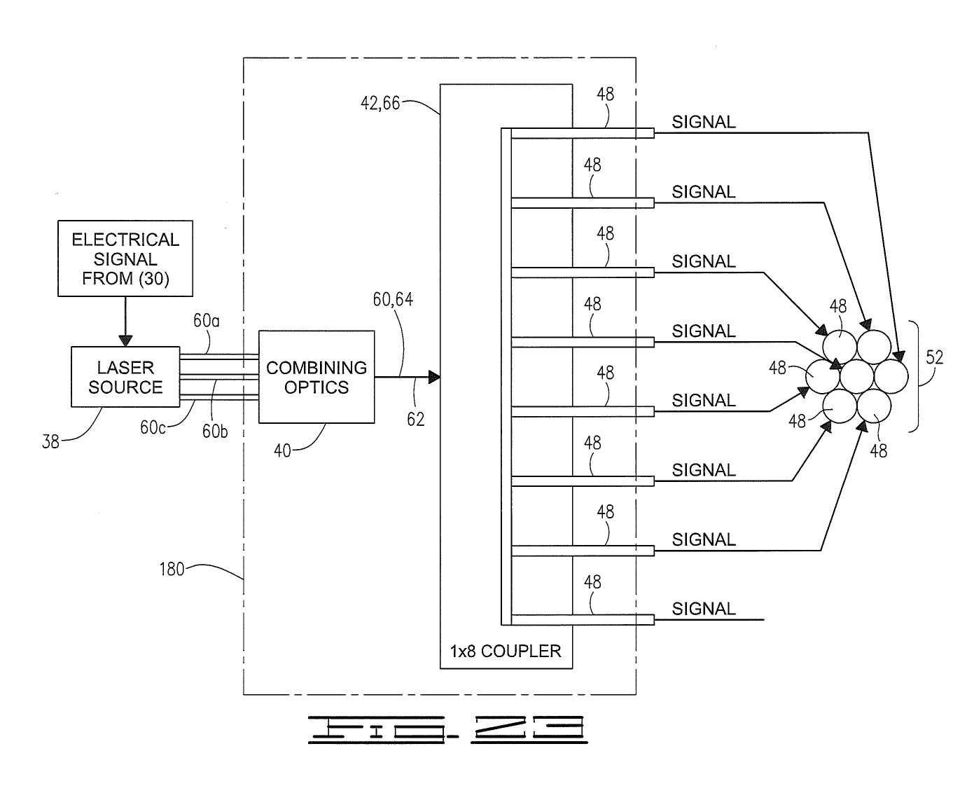

Transmitter control system 42 includes a combination of power splitters 66 and/or switches 68 directing multiplexed optical signal 64 to one or more transmit fiber optic cables 48 in fiber bundle 52. Power splitters 66 and switches 68 are known and the control mechanisms and functionality will not be discussed. A schematic representation of power splitters 66 and switches 68 is shown in FIGS. 23-25. Each transmit fiber optic cable 48, also referred to as transmit fiber optic 48, associated with an individual fiber bundle 52 uses lens 46 to direct light to an area where the receiver 24 is expected or supposed to be without the need of mechanical steering components. In a non-limiting example, transmitter sub-unit 36 uses seven transmit fiber optic cables 48 per fiber bundle 52, thereby implementing the use of seven transmitters 22.

Transmitter control system 42 and processing and control module 28 provide fine adjustments to alignment between access node 12 and mobile origination node 15. The fine adjustment is achieved by monitoring the optical power of beam 61. In embodiments where beacon beam 72 and quadrant detector 32 is used, the electrical signal of quadrant detector 32 and is also monitored to assist with the fine adjustments. In the embodiments where PAT 86 is used, e.g. beam 72 is propagated by source 38, the fine adjustment is achieved by detecting the differences in the power collected from transmitter 22 by fibers representing cardinal locations in PAT system 86. Transmitter control system 42 and processing and control module 28 provide inputs to divergence adjuster 50 to align the optics of the access node 12 and the mobile origination node 24 and to increase the signal power of beam 61. Transmitter control system 42 and processing and control module 28 also provide adjustment of the mobile origination node 14 and access node 12, and provide line-of-sight corrections thereto based upon the continuous monitoring of the signal power from beam 61.

Processing and control module 28 defines the control system that multiplexes wavelengths 60a-60c, operates transmitter control system 42, and emits the proper signal to fiber bundle 52. Processing and control module 28 also defines the control of lens 46.

Lens 46 is capable of movement, thereby controlling the divergence and steering of beam 61. Divergence and steering are controlled by fiber-lens distance (Z_{fl}) 74, and by selecting the desired illuminated transmit fiber optic cable(s) 48 from fiber bundle 52, respectively. Divergence adjuster 50 defines the movement of lens 46. Divergence adjuster 50 and the selection of transmit fiber optic cable(s) 48 are controlled by logic, e.g. programming code, within processing and control module 28. In one embodiment, divergence adjuster 50 is an electromechanical device providing mechanical positioning control, or the physical adjustment, of Z_{fl} 74. However, divergence adjuster 50 also includes electrical and electro-optical adjustment of Z_{fl} 74. The adjustment of Z_{fl} 74 defines the magnitude of the divergence of beam 61. Also, divergence adjuster 50 provides the adjustment of Z_{fl} 74, the distance between lens 46 and fiber optic cable(s) 48.

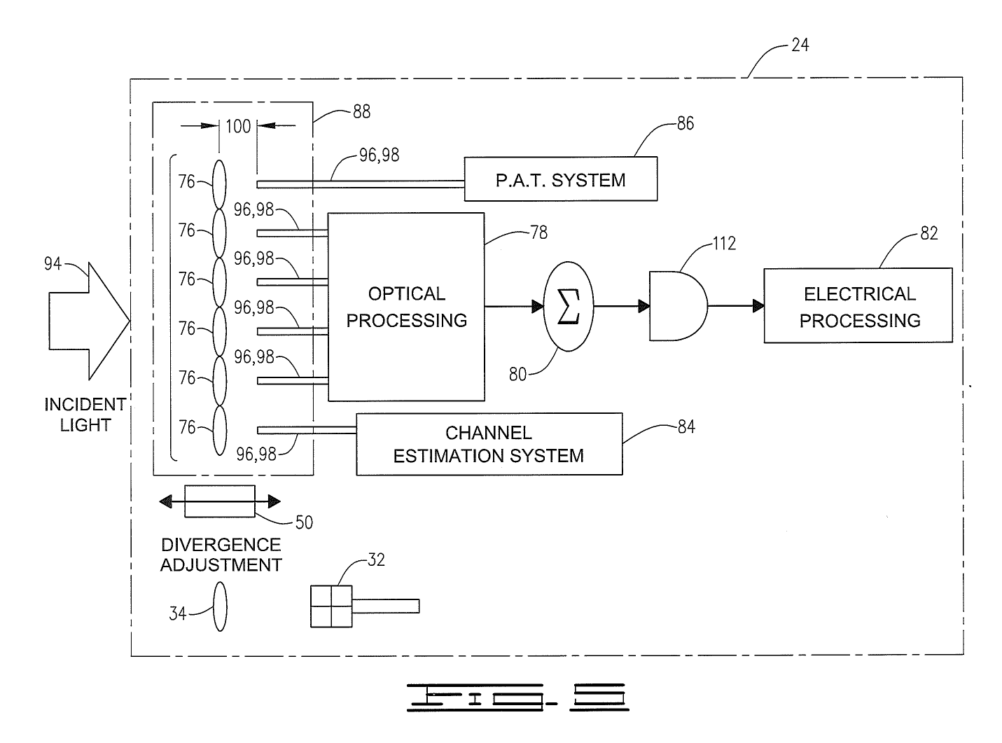

Turning to FIGS. 3 and 5-9, each receiver 24 includes at least one collecting optic, also referred herein as collecting lens 76, optical processor 78, signal summation 80, electrical processor 82, and channel estimator 84. In the embodiment illustrated, PAT system 86 is also associated with receiver 24. Receiver 24, illustrated in FIGS. 5-9, depicts receiver sub-unit 88. Receiver sub-unit 88 of receiver 24 includes a plurality of small collecting lenses 76 forming lens array 90, which optically communicate with at least one collecting fiber optic cable 96. Receiver 24 may have a plurality of receiver sub-units 88 with a set of optical components for collecting power from several free-space optical beams. As illustrated in FIGS. 6-8, each receiver sub-unit 88 has a dedicated optical axis 92, and thus a pre-set reference about which receiver sub-unit 88 will accept source 94 transmissions. As used herein, source 94 transmissions are also referred to as optical communication signal 61.

A representative collecting fiber bundle 98 is illustrated in FIGS. 6-9 with multiple fiber optic cables 96 positioned behind each collecting lens 76. Collecting lens 76 functions as a collecting optic. Collecting lens 76, in conjunction with fiber optic cable 96, define an entry point for at least one wavelength 60 and define an optical communication path between source transmission 94 and optical processor 78. Transmitter 22 and receiver 24 interactively provide the bi-directional communication for the first and second transceivers.

Collecting lens 76 parameters, fiber optic cables 96 spacing within fiber bundle 98 and fiber optic cables 96 size are selected to receive transmissions from different angles and focus the transmissions onto different collecting fiber optic cables 96 within fiber bundle 98. Each collecting lens 76 is positioned with a specific separation from the adjacent collecting lens 76, as well as having distance 100 from a corresponding fiber optic cable 96. As shown in FIG. 5, divergence adjuster 50 is also located within receiver 24. As in the transmitter, divergence adjuster 50 within receiver 24 defines the movement of collecting lens 76, thereby providing an adjustment of distance 100 between collecting lens 76 and corresponding fiber optic cable(s) 96. In one embodiment, divergence adjuster 50 is an electromechanical device providing mechanical positioning control, or the physical adjustment, of 100. However, divergence adjuster 50 also includes electrical and electro-optical adjustment of distance 100. The adjustment of distance 100 defines the length for which the maximum amount of power is coupled into the fiber optic cable 96, which is often the focal length of the collecting lens 76.

Additionally, each fiber optic cable 96 is separated from the adjacent fiber optic cable 96 within fiber bundle 98; thereby ensuring incident light propagating from different angles relative to optical axis 92 is incident on, and collected by, different fiber optic cables 96 in lens array 90, as illustrated in FIGS. 6, 8, and 12. The separation for each optical element depends on the selected focal length of collecting lens 76, and the size of the core of fiber optic cable 96. The determination and selection of the focal length of collecting lens 76 is within the purview of a person having skill in the relevant art. Likewise, the determination of the size of the core of fiber optic cable 96 is also within the abilities of a person having skill in the art. The fiber optic cable 96, positioning as discussed herein, ensures that transverse misalignments are not mistaken for angular variations, and thus do not cause interference when two sources are coupled to the same fiber optic cable 96. An array of collecting lenses 76 coupled to a single or multiple fiber optic cable(s) 96 reduces the effects of angular and transverse misalignment so that a single receiver 24 can better track one or more transmitters 22.

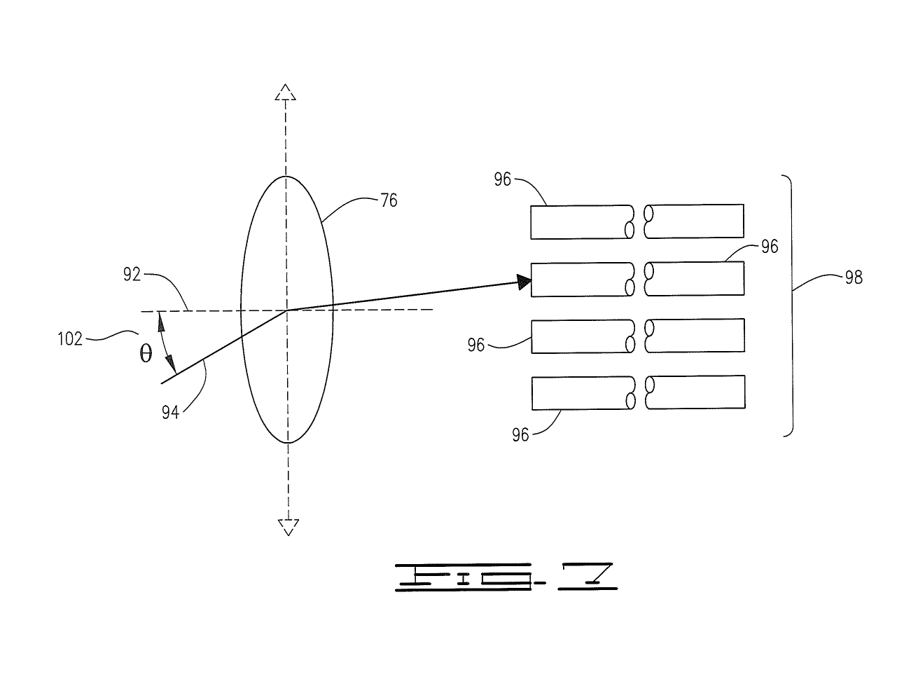

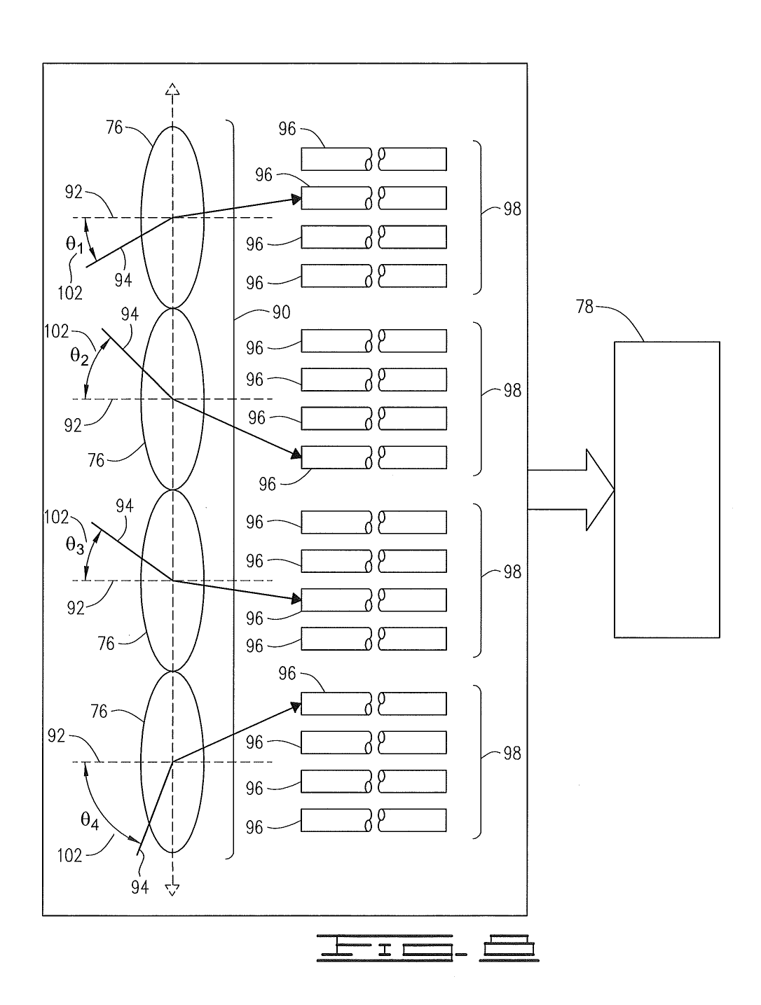

The number of receiver sub-units 88 used in receiver 24 depends on the angular resolution and range needed for a particular application, as determined by one skilled in the art. As shown in FIGS. 6-8 and 12, light from source 94a and source 94b is separated based on incoming angle 102 and directed to one of the multiple fiber optic cables 96 associated with lens array 90 and collecting lenses 76. As shown in FIGS. 7 and 8, different angles 102 are captured by one of the fiber optic cables 96 within fiber bundle 98, thereby reducing the effects of angular alignment and giving each receiver sub-unit 88 a larger field of view. For simplicity only one light source 94 and incoming angle 102 is depicted in FIGS. 7 and 8 for each collecting lens 76. Those skilled in the art will appreciate that each individual collecting lens 76 within lens array 90 may receive light from multiple sources 94.

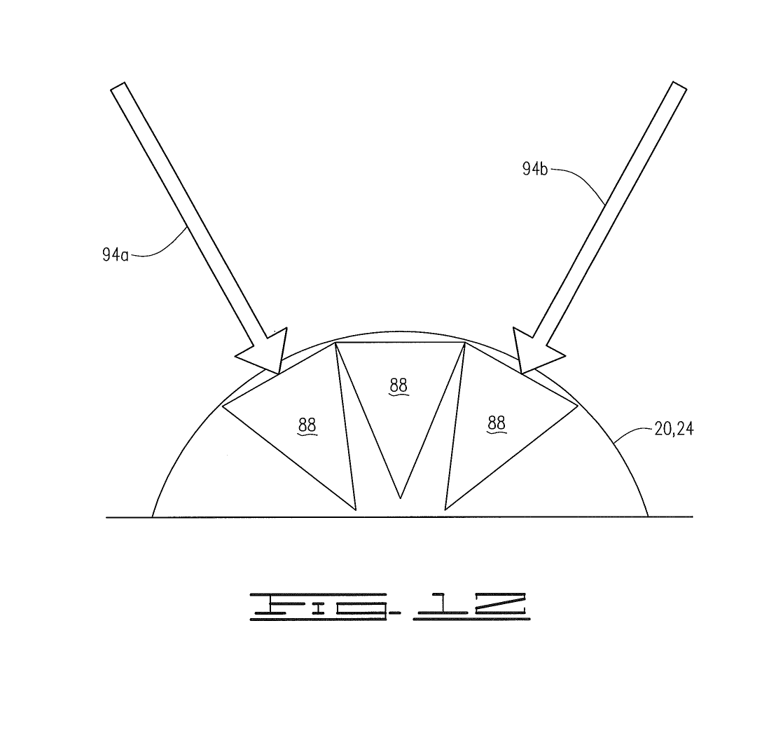

Receiver sub-units 88 are positioned such that only those receiver sub-units 88 intended to receive the signal from sources 94a and 94b will direct light to fiber optic cables 96 thereby allowing for receiver sub-units 88 to observe signals from transmitters only within the receiver sub-unit's 88 particular cone of view. Receiver sub-units 88 not intended to receive the signal from sources 94a and 94b will direct any light from sources 94a and 94b away from the collecting fiber optic cables 96. FIG. 12 illustrates multiple origination nodes propagating wavelength 60 (signal from sources 94a and 94b) to a single receiver 24 where each signal communicates with a particular sub-unit 88 within receiver 24.

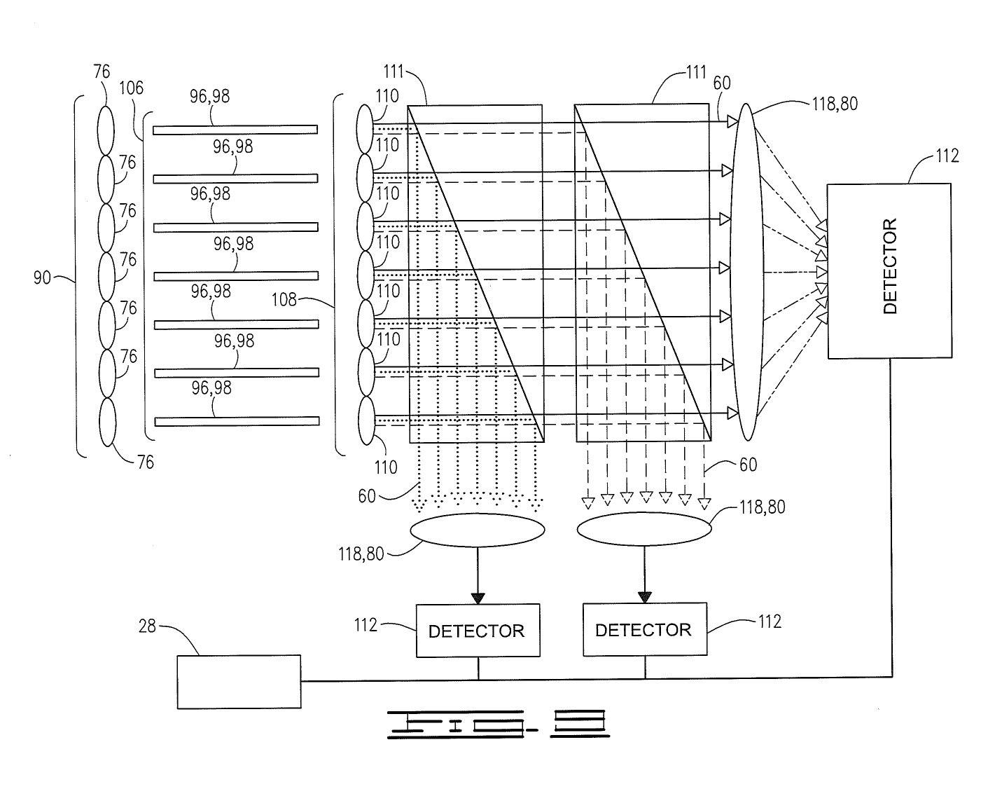

One processing technique of optical processor 78 is illustrated in FIG. 9. Once the light is communicated in fiber optic cables 96, the different signals are collected and converted by optical processor 78 to an electrical signal using one of many available hardware elements, techniques and processes. The optical signal to electrical signal conversion provides for processing and responding to communications with receiver 24. Optical processor 78 includes communication paths 104, processing bundle 106, microlens array 108 having a plurality of microlens 110, splitting component 111, e.g. an optical splitter, and detector 112. Detector 112 is preferably a phototransistor photo detector having an active area capable of operating at optical data rates up to at least 2.5 Gigabytes/second (GB/s). Detector 112 is in electronic communication with processing and control module 28, and provides power monitoring of wavelength 60 impacting detector 112. One embodiment utilizes at least four detectors 112, wherein each detector 112 receives an optically communicated wavelength 60 via fiber optic cables 96. The cardinal directions define the directions up, down, left and right for fine and/or gross adjustments to correct pointing errors. Another embodiment utilizes at least two detectors 112, wherein one detector 112 is used for optical alignment of the units and the other detector is used for power detection and processing. In other embodiments, three detectors may be used. Splitting component 111 is positioned in the optical communication path and redirects a small portion of the power in wavelength 60 to detector 112. Additionally, optical processor 78 is connected to and in electronic communications with a plurality of communications cables (not shown) connected thereto.

To accomplish the optical processing, optical processor 78 is configured to separate the received signals described above. The separated signals are summed using signal summation component 80. As shown in FIG. 9, signal summation component is aspheric lens 118. Other separation and summation techniques can be used, for example, separating and combination of the signal based on wavelength or a type of signal. After summation, the optical power from each fiber optic cable 96 is presented to detector 112.

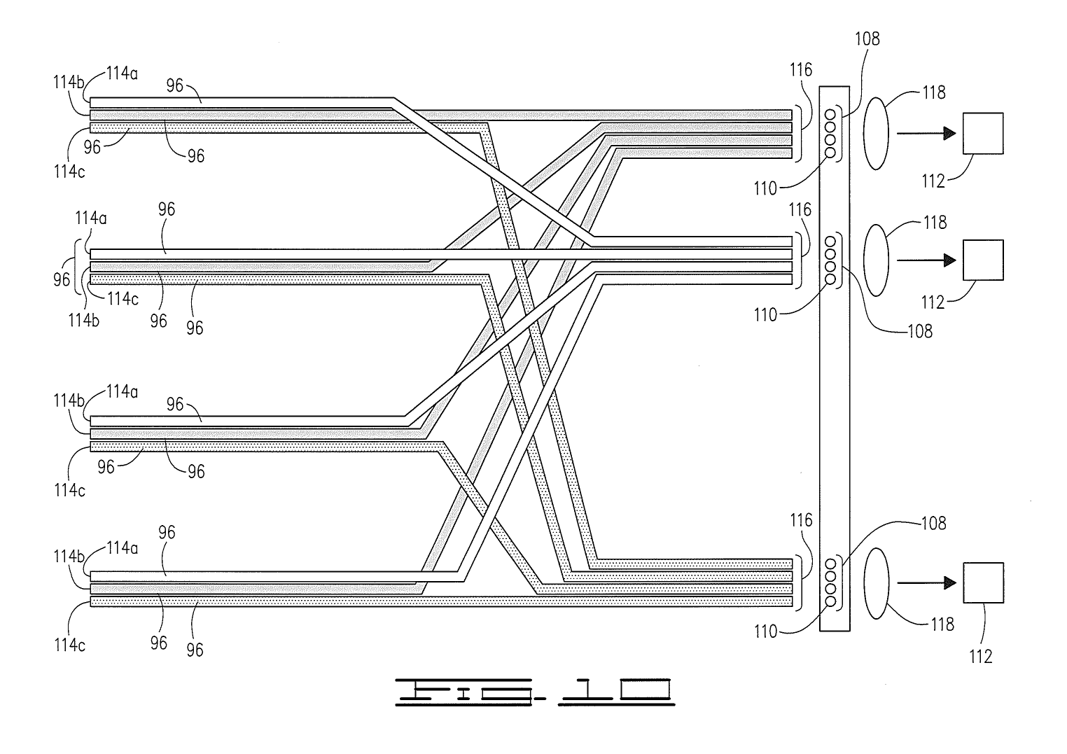

FIG. 10 illustrates another embodiment of optical processor 78. As shown in FIG. 10, signals from different sources are separated into different communication paths 104. Input signals 114a, 114b and 114c are different signals communicated by a unique fiber optic cable 96 within the fiber bundle 98 carrying that particular signal. Each fiber optic cable 96 carrying a particular signal is sorted into a new fiber bundle 116. New fiber bundle 116 also serves as a secondary fiber optic cable 96. New fiber bundle 116 is a new bundle of fibers made from the individual fibers split out from the fiber bundle 98. Each new fiber bundle 116 is coupled to microlens array 108, with one microlens 110 per secondary fiber optic cable 96. Microlens 110 collimates the light from the fibers, making this light easier to capture and process.

Aspheric lens 118 aggregates the multiple collimated light beams and focuses them onto the active area of detector 112. Using aspheric lens 118 prevents difficulties due to aberrations commonly induced by spherical lenses. Aspheric lens 118 is capable of focusing light incident on any part of its surface onto a focal area of only a few square micrometers. In a non-limiting example, the active area of the phototransistor portion of detector 112 is preferably small in size, or about 0.1 millimeter squared (mm²) to about 0.5 mm², and provides for fast and correct responses to high-speed data signals about 1 GB/s, or greater. The focusing of the light on the active area of the phototransistor portion of detector 112 requires that the light be efficiently and effectively communicated to the active area of detector 112, thereby maximizing the speed of the correct responses of the high-speed data signals.

Optical summation 80 combines the power of input signals 114a, 114b or 114c in the individual fiber optic cables 96 onto a detector 112. Some input signals 114a, 114b and/or 114c are dominantly associated with a single fiber optic cable 96 and are not summed. Processing in the optical domain is accomplished with optical processor 78, and processing in the electrical domain is accomplished with electrical processor 82. The signal travels along communication path 104. There may be different communication paths 104 for different wavelengths 60 used by the transmitter 22. Communications path 104 is depicted by the various hatch and hash marks in FIG. 10 of wavelength 60. In a non-limiting example, the optical processor 78 may function in any of the following ways:

(a) As shown in FIG. 10, individual fiber optic cables 96 are directed to different aspheric lenses 118 for summation, effectively making aspheric lenses 118 summation unit 80. The fiber optic cables 96 can be separated by location as shown in FIG. 10.

(b) As depicted in FIG. 9, fiber optic cables 96 can be individually filtered to deliver power from only a specific wavelength. For example, a bulk (non fiber-based) tunable filter (splitting component 111) positioned between the fiber outputs and the summing lens 118, allows different wavelengths (from different transmitters 22) at different times.

(c) A fiber-based or bulk optic splitter can divide the optical power between two detectors 112 thereby allowing different processing of the signal at two different locations as shown in FIG. 9 at the second splitting component 111.

It should be appreciated by one having skill in the art that optical processor 78 may function in various ways, while recognizing that any process/methodology for achieving the overall effect of receiving optical signal(s) from one or more sources, directing the received optical signal(s) to one or more detectors, and converting the optical signal(s) into electrical signal(s) allows for completion of multiple optical communication paths by a single receiver. Optical processor 78 thereby enables the separation, by wavelength or position, of optical communication signals carrying different information to be detected and processed by separate systems. Optical processor 78 also allows for separation, processing, and monitoring of power within a signal to be utilized for different purposes or to allow multiple signaling protocols, including SONET, ATM, IP, and Ethernet, within the message to be used within the same receiver unit.

Referring to FIGS. 3 and 5, electrical processor 82 receives the electrical signal from detector 112. Several different electrical processors 82, and designs thereof, capable of receiving a signal from detector 112 are available on the market. Thus, the person having skill in the relevant art understands how to receive an electrical signal from detector 112 and process that signal into a communications signal.

Those skilled in the relevant art understand PAT systems 86 and are able to provide numerous different designs. Thus, PAT system 86 is any PAT system capable of providing sufficient pointing, acquisition and tracking between access node 12, origination node 14 and/or relay node 15, and by integrating with channel estimator 84 and processing and control module 28. For example, a beacon laser 72 from the second transceiver 20 is captured by a wide field-of-view lens, detection lens 34, also called the fish-eye lens, and delivered onto the active area of a quadrant detector 32, where position error information is calculated. The position error information is fed into a computational engine, i.e. processing and control module 28 performing a first protocol, to determine where the transmitter 22 should point to direct the beam 61 at the receiver 22 of the second transceiver 20. Processing and control module 28 issues control signals to point the transmitter at the receiver of the second node and steer/scan the transmitter beam for adjustments until the receiver of the second node is contacted. In one embodiment, this is achieved with gimbals or small motors that allow several degrees of freedom in movement, and the beam steering is usually accomplished by a fast steering mirror.

Channel estimator 84 provides for optical channel estimation using the input signal from beacon 26, and providing an electronic output to processing and control module 28, transmitter 22, receiver 24 and PAT system 86. The electronic output is a signal providing information on the properties of the optical channel, specifically statistics related to turbulence and weather, such as temporal coherence time, spatial coherence, fading variance, and loss due to attenuation by rain or fog. As illustrated in FIG. 1, an optical channel, depicted as communications path 120. Communications path 120 is the path of communications taken by beams 61 and 72. Optical communication is accomplished using wavelength 60. Channel estimator 84 provides at least an input for the fine alignment control to point, acquire, and track between each node. Channel estimator 84 also provides the input to assess the quality and power of the incoming optical signal 61, also referred to as source 94, to receiver 24, and to select the optimum wavelength 60 to propagate through the atmosphere and its associated conditions.

Alternatively, radio frequency (RF) technology may supplement PAT system 86. For example, a hybrid system may exchange global positioning system (GPS) data with PAT system 86 to further enhance PAT system 86. A hybrid system is one which uses both optical and RF communication between at least one pair of nodes. In addition, all nodes may be equipped with RF communication capabilities in the event no optical signal can be achieved between any nodes due to various factors, for example, weather, equipment failure, etc.

In a non-limiting example, during operation, mobile origination node 14 uses detector 112 to search for beacon beam 72 to locate access node 12 and/or relay node 15. Beacon beam 72 from the first transceiver is imaged onto the quadrant detector 32 through detection lens 34 at a second transceiver.

Detection lens 34 is a wide field-of-view lens, commonly referred to as a fish-eye lens. Standard electronics within quadrant detector 32 provide electrical signals to indicate how far the imaged beacon has deviated from the center of the quadrant detector 32. In another embodiment, the position of signal beam 61 (or source input 94) with respect to the center of the receiver's optical axis is detected using lens 76 and PAT system 86. PAT system 86 provides similar electrical signals as previously described for quadrant detector 32. The electrical signals from quadrant detector 32, or PAT system 86, are communicated to processing and control module 28 for analysis. Processing and control module 28 combines the information in these electrical signals with the distance between transmitter 22 and receiver 24 to calculate how far the first transceiver's receiver 22 has moved away from the optical axis of the transmitter 22 of second transceiver 20. Processing and control module 28 is configured with information of the transmitter configuration, e.g. number of transmitting fibers 48, separation between transmit fibers, focal length of transmitting lens 46 and the tracking protocol in use. Processing and control module 28 determines which transmitting fiber(s) 48 should be lit with optical power and sets the state of the optical switches in switch network 180 to direct the transmitter power to the desired transmit fibers 48. It should be appreciated that processing and control module 28 may include at least one microprocessor capable of controlling and communicating with multiple devices within transceiver 20.

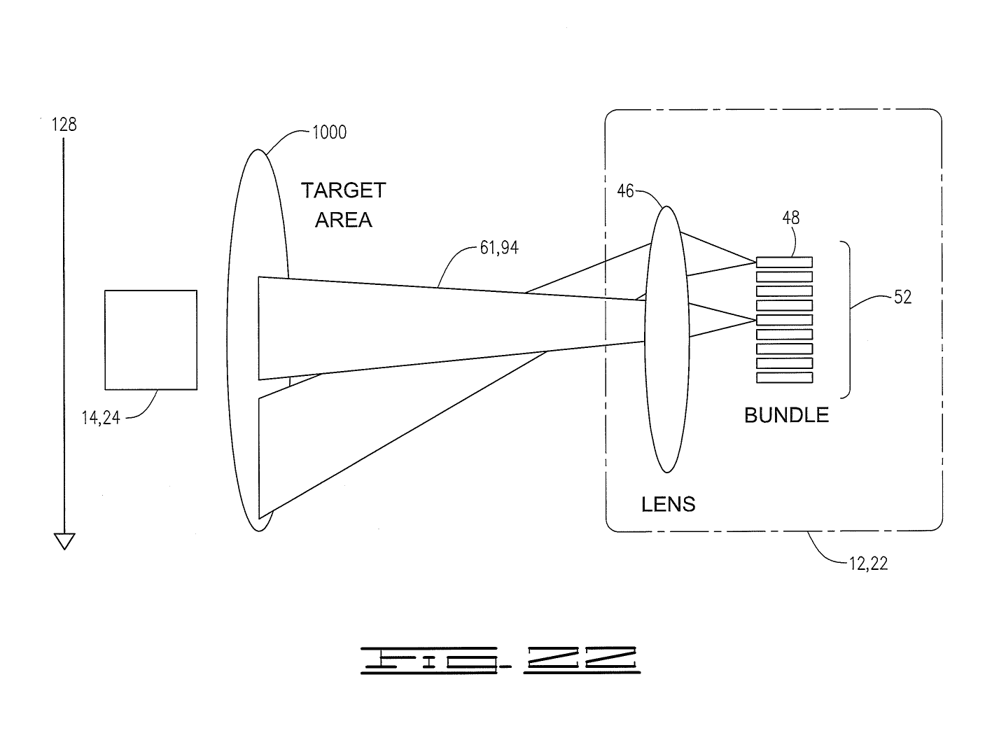

For example, to determine which transmitting fiber(s) 48 should be lit with optical power, the processing and control module 28 considers the situation depicted in FIG. 22. The target receiver 24 moves within a target area 1000 with movement 128. The light emitted by the transmitting fiber(s) 48 within bundle 52 illuminates a fraction of target area 1000 with optical power. The fraction of the target area 1000 illuminated with enough power to complete the communication link is referred to as the coverage area. The coverage area is determined by Z_{fl} 74, transmitting lens 46, and the distance between transmitter 22 and receiver 24. Processing and control module 28 calculates which transmit fiber(s) 48 would, when illuminated, produce a coverage area that includes the current and near future positions of the target receiver 24. As the target receiver 24 of mobile origination node 14 continues to move, processing and control module 28 can use the signals from quadrant detector 32 (or from PAT 86) to determine the next set of transmit fiber(s) 48 to illuminate through switch network 180 in order to keep the receiver within the coverage area of beam 61.

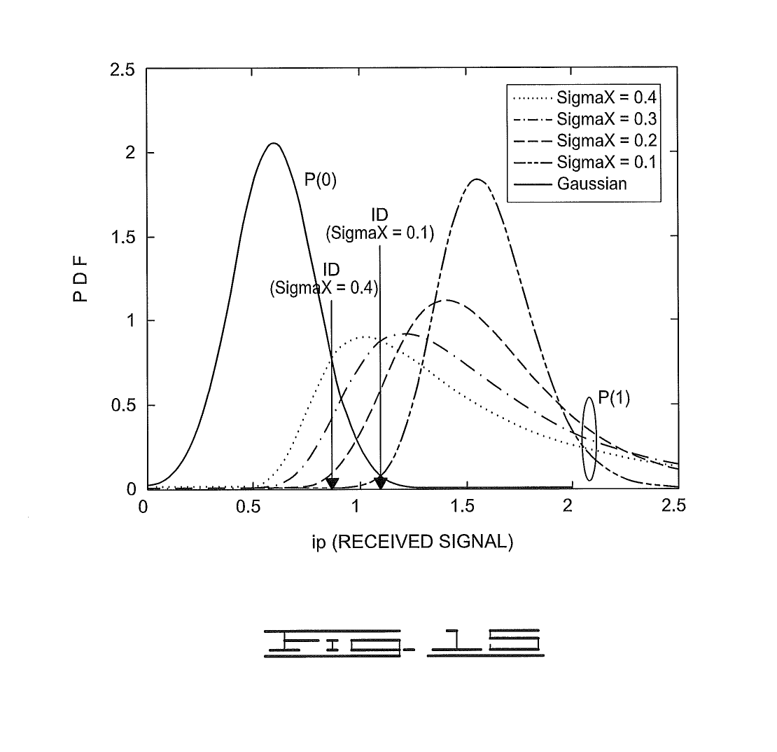

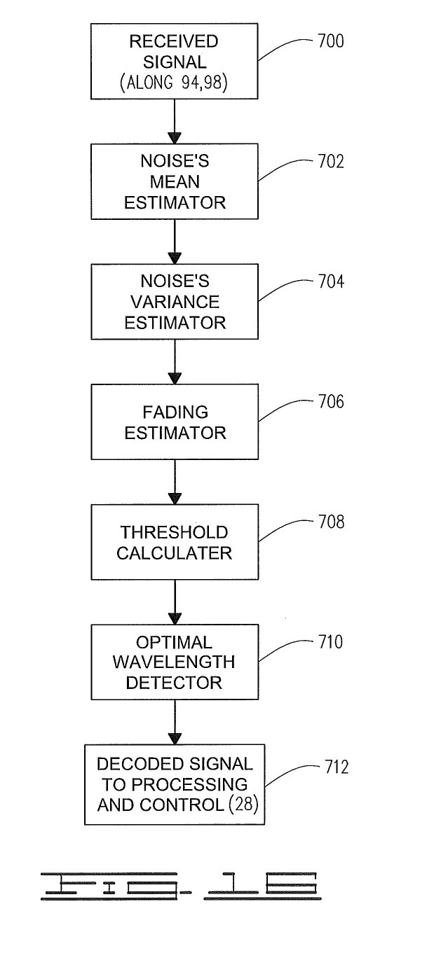

Regarding channel estimator 84, when propagating wavelength 60 having optical signal 61 through the atmosphere, wavelength 60 will experience degradation and loss of power inherently induced by the atmosphere. Laser 38, its wavelength 60 transmission, and the associated signal are impacted by different weather conditions and atmospheric turbulence. The beam quality of beam 61 is affected by the weather conditions. The degradation and loss of power of laser 38, wavelength 60 and the associated signal results in signal fading. Signal fading also occurs when the laser's wavelength 60 line-of-sight between transmitter 22 and receiver 24 is not optimum and/or includes a portion of the beam. Optical channels 120 are also negatively influenced by atmospheric turbulence. FIGS. 15 and 16 depict the result of the turbulence with the intensity fluctuations of the optically received signal and a block diagram of the approach of channel estimator 84 to dynamically estimate the best channel for communications between nodes, respectively. Referring to FIG. 15, the stronger the turbulence, the deeper signal fading will be, which ultimately results in the severing of the optical link between transmitter 22 and receiver 24. Channel estimator 84 and processing and control module 28 control the selection of the particular laser 38 and wavelength 60 appropriate for propagating through a given atmospheric condition to avoid signal fading.

In one embodiment, channel estimator 84 is based on pilot-assisted, multi-slot averaging. Different wavelengths 60 provide different information about channel conditions. Channel estimator 84 provides information on expected performance of the channel, which becomes the basis for exercising control over the optical beam parameters.

The availability of multiple wavelengths 60 in transceiver 20 provides for increased accuracy in fading channel estimation. Wavelength 60 transmissions is impacted differently depending on weather conditions and atmospheric turbulence. Thus, receiver 24 carries additional channel state information (CSI), such as and including the ability to measure signal strength and SNR measurements. A pilot signal (either embedded in the data transmission sent in optical signal 61, or transmitted by beacon 26) utilizes different wavelengths 60 to transmit and receive data, and then calculate CSI. After the channel is estimated, a proper wavelength 60 is selected for actual data transmission.

Receiver 24 is equipped with an optimal detection receiver and uses simple intensity modulation/direct detection (IM/DD) and on/off keying (OOK) with knowledge of CSI at receiver 24. Simple IM/DD and OOK are known to those skilled in the art, and are not discussed in detail herein. Given that fading between the data transmission channel and pilot channel is correlated, the CSI calculation will be valid for signal detection.

One embodiment estimates CSI using pilot symbol assisted modulation (PSAM) employing multi-slot averaging (MSA) to dynamically calculate the detection threshold at receiver 24. In this embodiment, it is assumed that atmospheric turbulence affects the channel, and that the channel is time-invariant over a given observation. The probability distribution functions for bits ‘0’, p(0), and ‘1’, p(1), are not equal in an FSO link employing OOK signal due to the fact that the bits suffer different noise statistics. Fading has no effect on p(0), as p(0) stays Gaussian distributed, whereas p(1) is convolved with the fading distribution, e.g. lognormal distribution, causing threshold value changes as a result of fading intensity. It is assumed that the ML-derived threshold, shown in FIG. 15, provides optimal detection when fading variance of σₓ=0.1, the threshold is not optimal for different fading intensities, e.g., σₓ=0.2, σₓ=0.3 and σₓ=0.4. A block diagram of the approach used to dynamically update the threshold using the obtained CSI, thus achieving optimal detection of OOK modulation with direct detection in turbulence fading channels, is illustrated in FIG. 16.

Referring to FIG. 16, by way of example, illustrates a third protocol. At block 700, the channel estimator 84, located at receiver 24, interrogates channel 120, received along fiber bundle 98 and determines the channel's statistics, also referred to as channel state information (CSI). Channel estimator 84 performs the calculation of such channel statistics including: the noise's mean (noise's mean estimator 702), variance (noise's variance estimator 704), fading variance (fading estimator 706), threshold calculator 708, and temporal coherence, and/or spatial coherence. Nearby weather stations may also provide input on the local weather at the transmitter 22 and receiver 24 of each transceiver 20. In other embodiments, a weather monitoring module may be integrated with each transceiver 20. At block 710, the optimal wavelength detector then determines which of the available wavelengths at the transmitter would have the best potential for establishing a high-quality signal between the transceivers. The information on the selected wavelength is transmitted back to the transmitter, for instance, through beacon 26. When both sides of the communications link 120 contain full transceivers 20, e.g. transmitter 22 and receiver 24, the channel estimator 84 at the transmitter 22 (first transceiver) may also make a determination of the appropriate wavelength since there may be different weather at the first transceiver than at the second transceiver. The first transceiver evaluates the wavelength choice information and selects the wavelength that is most likely to provide the highest-quality connection.

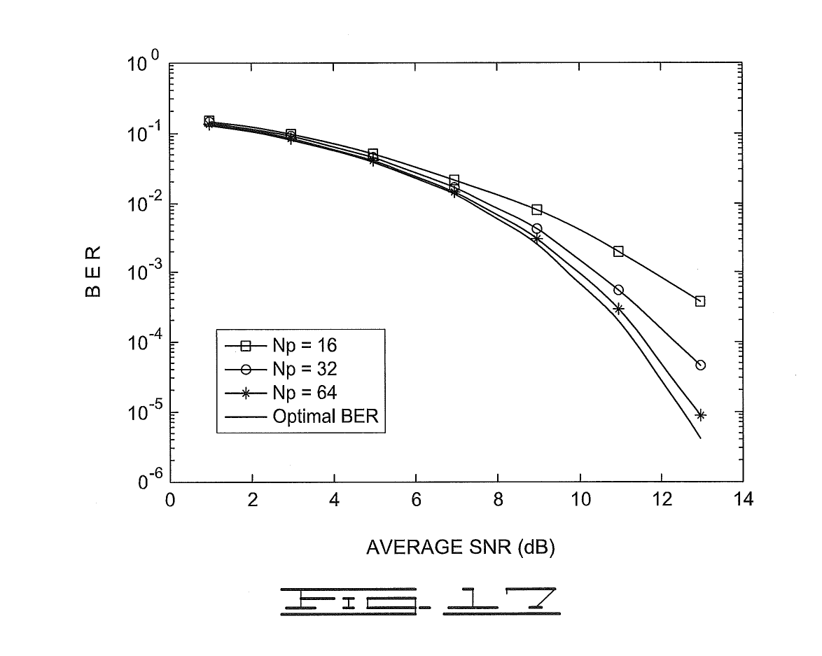

FIG. 17 shows bit error rate (BER) performance resulting from the above referenced MSA estimation in a Lognormal channel with fading intensity of σₓ=0.1. FIG. 17 illustrates the estimation procedure for three pilot bit values, namely Nₚ=16, 32, and 64. As illustrated, Nₚ=16 does not provide an accurate estimation of noise statistics for the observed SNR ranging 1 to 13 dB. Instead, Nₚ=64 gives more acceptable noise statistics—a maximum of 0.3 dB deviation in SNR, maintaining BER at 10⁻⁵. In more general terms, referring to the BER, as a link where the alignment between transceivers and the wavelength selection is optimal may fail if the BER is too high (typical threshold values for a failure in wired optical links are about greater than or equal to 1×10⁻⁶ to 1×10⁻⁷. Low BER is achieved by selecting the appropriate threshold between a “0” and a “1” (FIG. 15) and by selecting the correct structure of the data packet (for example, number of pilot bits, see FIG. 17) to improve estimation of the channel state information.

The performance of FSO network 10 is measured using several parameters, including: the time required to establish a link to access node 12; link downtimes due to wavelength 60 switching and external perturbations; time to acquire the link between origination nodes 14 at a desired BER and bit rate; and RAC performance parameters. RAC refers to receiver access control protocol, and is also referred to as a second protocol herein.

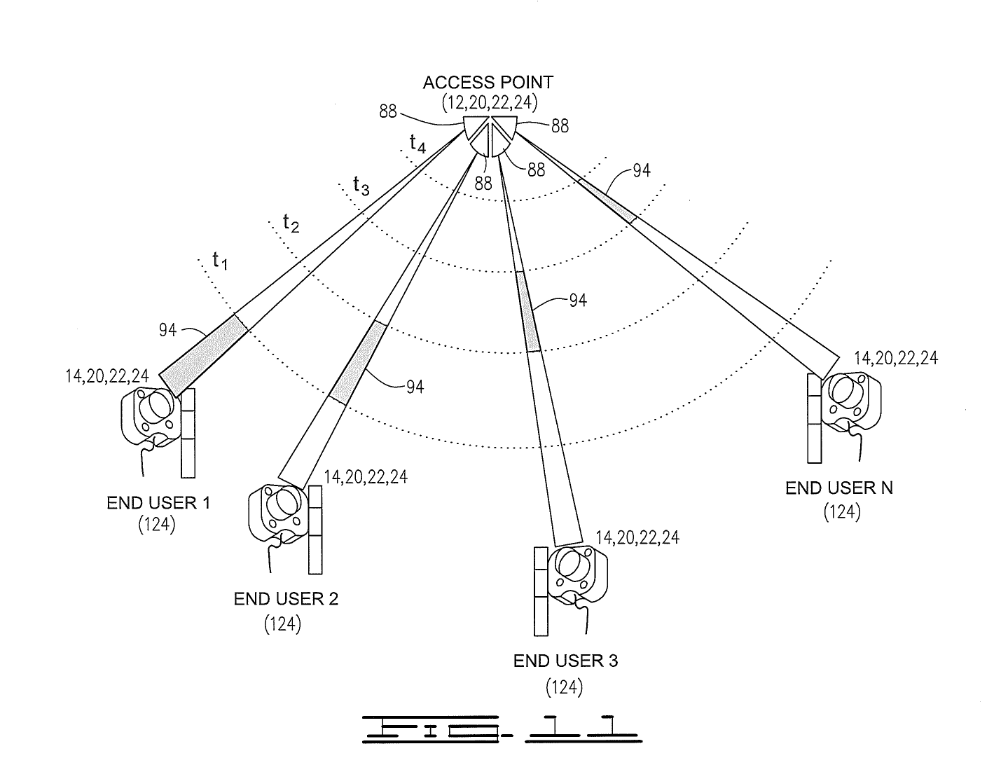

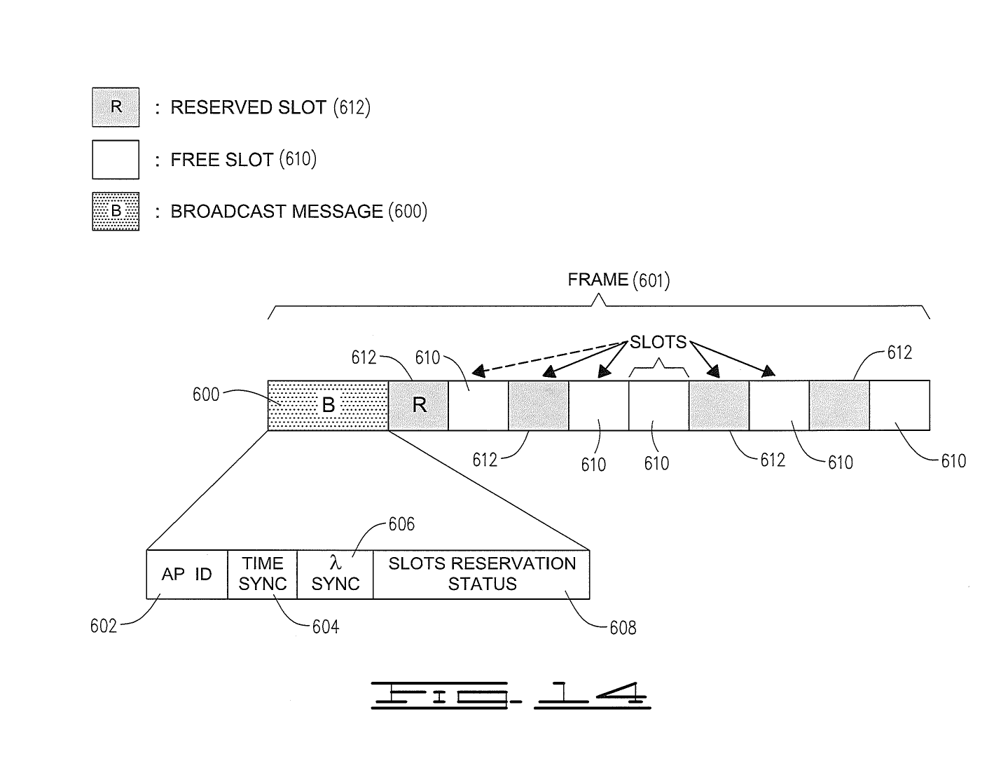

FIG. 14 illustrates communication message frame 601. Frame 601 includes time slots for communication between nodes, for example, reserved slots 612 and free slots 610, and a broadcast message 600. Within broadcast message 600 is AP ID 602, time sync 604, wavelength sync 606, and slot reservation status 608. AP ID 602 is an access point identification (the identification of the access node the origination node is communicating with or attempting to establish a communication with). Time sync 604 contains synchronization or alignment information of the time slots including duration of each time slot. Wavelength sync 606 contains the wavelength information the nodes will use to communicate. In the RAC protocol, the origination node (end user) 14 sends a request to connect with access node 12. Access node 12 determines if there are any free time slots available for the origination node 14 to transmit in. Access node 12 will assign each origination node 14 an assigned time slot for transmission (as shown in the FIGS. 11 and 14), and communicate the time slot information back to the origination node 14 in the broadcast message 600. Each origination node 14 transmits data to the access node 12 only in its assigned time slot (as depicted by 94 in FIG. 11) to avoid collisions, i.e. simultaneous transmission of signals by one or more origination nodes 14 that interfere and destroy the signal quality. In the event there is not an available time slot within frame 601, access node 12 will deny the request from origination node 14. A reason for denial of service is provided in slot reservation status 608 within broadcast message 600. Origination node 14 will continue to send requests to access node 12 for a predetermine amount of time or number of requests. The configuration regarding repeat requests will vary per FSO networks and application.

Referring to FIG. 1, a notional example of FSO network 10 is illustrated. Communications path 120 is illustrated as a bi-directional signal between multiple platforms which are all connected directly, or indirectly, to server 122. Server 122 in FIG. 1 represents network 16 in bi-directional communication with access node 12. In the example illustrated in FIG. 1, FSO network 10 is communicating from access node 12a to relay node 15 located on aircraft 124. Aircraft 124a is communicating in relay with aircraft 124b having origination node 14a thereon. Similarly, access node 12b is communicating with aircraft 124c having origination node 14b thereon. In addition, access node 12c is communicating with automobile 126 having origination node 14c thereon. Origination nodes 14a-c all represent mobile platforms communicating through FSO network 10.

In the example of FIG. 1, a plurality of nodes are illustrated as access nodes 12a-c and origination nodes 14a-c. Each node includes transceiver 20 and is capable of multi-angle, bi-directional line-of-sight optical communications with another transceiver 20 positioned within another node. Although not depicted, nodes may also be capable of mono-directional communications. Access nodes 12a-c are all in bi-directional electronic communication with the network 16 through server 122. Referring to access node 12b communicating with aircraft 124c having origination node 14b thereon, access node 12b has first transceiver 20a. Origination node 14b has second transceiver 20b. Aircraft 124c, the end-user in this example, obtains network 16 connectivity through origination node 14b and access node 12b. Processing and control module 28 is adapted to maintain line-of-sight optical communications between access node 12b and origination node 14b.

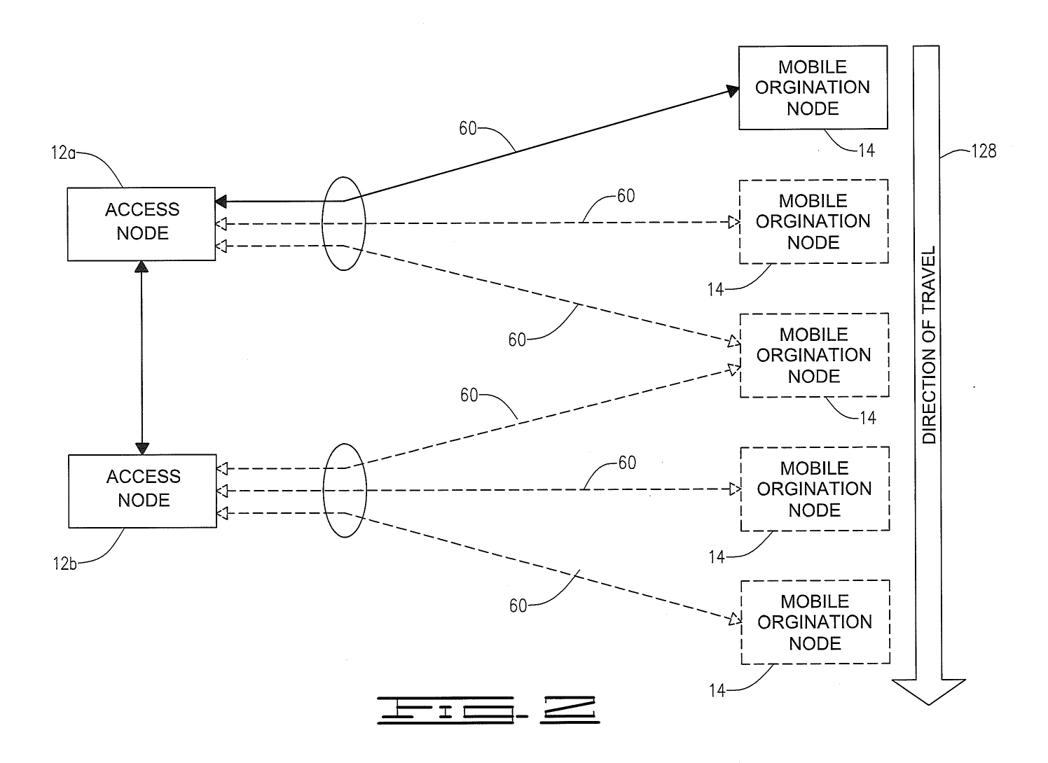

Referring to FIG. 2, the hand-off between access nodes 12 with a single origination node 14 is illustrated. Origination node 14 is in communication with access node 12a. As the physical location of origination node 14 moves along direction of travel 128, wavelength 60 propagates between each node. Processing and control module 28 and channel estimator 84 of each node defines a coordinated hand-off of the optical communication between each receiver 24 and the collecting optics 76, thereby providing for the continuity of optical communications as travel progresses. As origination node 14 nears the edge of access node 12a, wavelength 60 is handed off to access node 12b, thereby maintaining the continuity of the mobile system. This hand-off is achieved by the cooperation of processing and control module 28 and channel estimator 84 of each access node 12. The communications between each access node can include RF communications, wired communications, or optical communications.

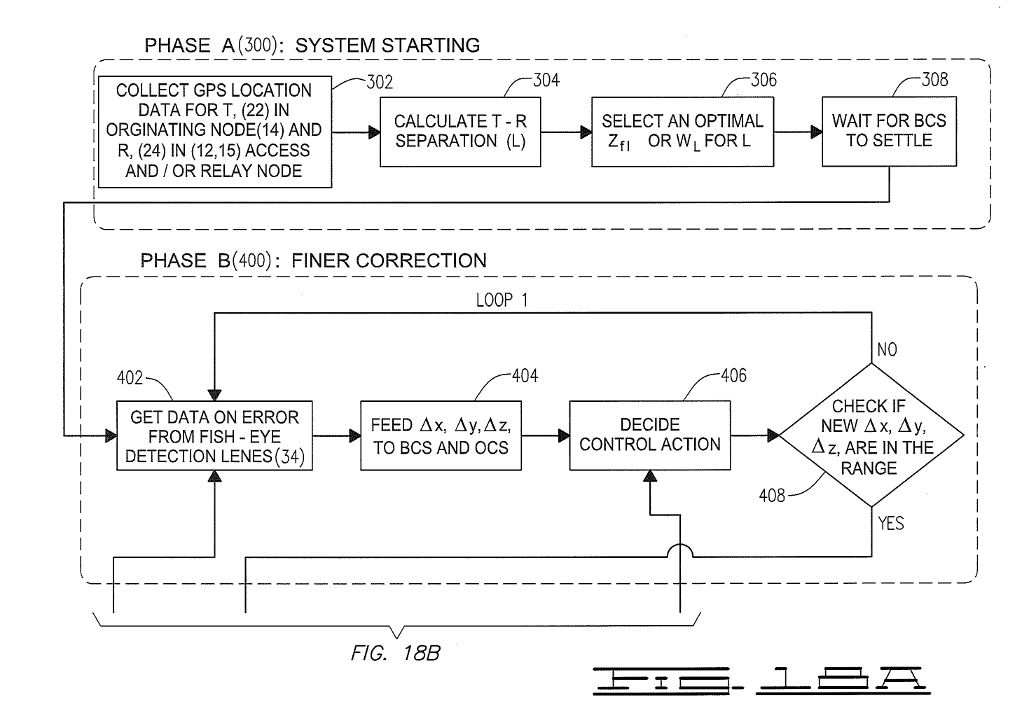

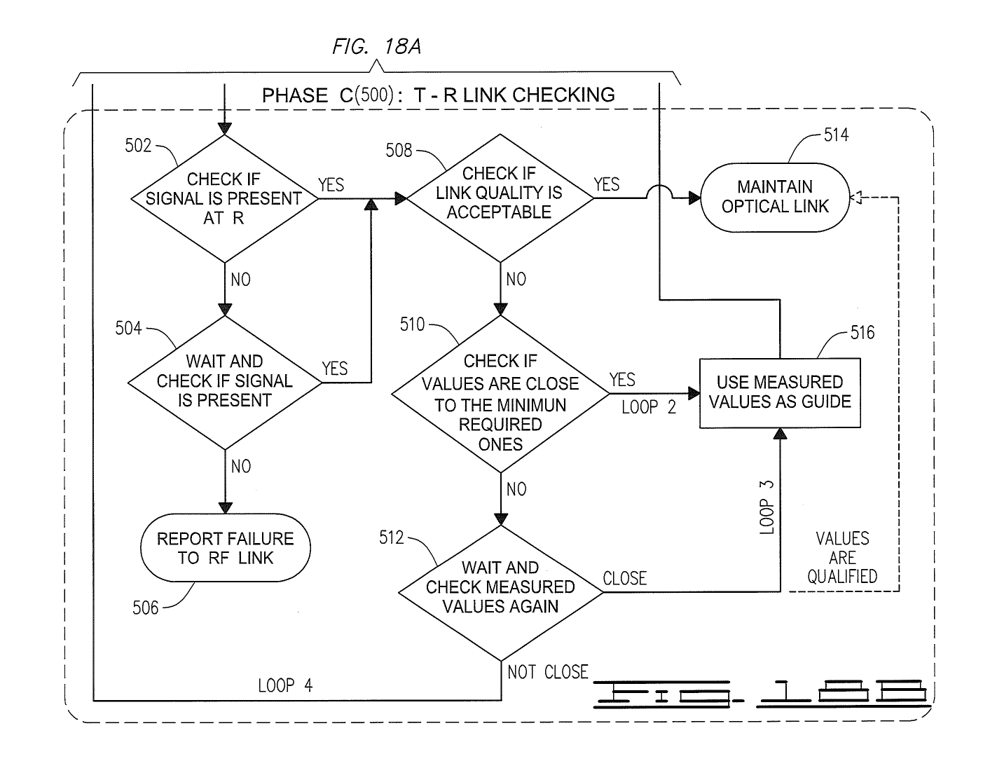

Referring to FIGS. 18-21, a first protocol and variations thereof is discussed. By way of non-limiting example, a first protocol, shown as a flow chart in FIGS. 18a and 18b, defines the alignment and re-alignment of the transceiver and includes an optical control algorithm containing three phases: Phase A: system start 300, Phase B fine focus correction 400, and Phase C: check of the optical link between transmitter and receiver 500. The first protocol is implemented by processing and control module 28.

For purposes of discussion of FIGS. 18a-21, a balloon control system (BCS) and Optical Control System (OCS) are used. As known to those skilled in the art, BCS is a set of motors or gimbals that move the entire transceiver, including fans and/or propellers, etc. that control the orientation and position of the balloon in space. It should be appreciated that BCS is one example of a gross adjustment system for transceiver 20, any components and any combination thereof capable of gross adjustments for transceiver 20 is suitable for the FSO network. OCS includes processing and control module 28, switch network 180, and divergence adjuster 50 and provides for fine adjustments, e.g. P₁ and/or Z_{fl} 74. It should be appreciated that OCS controls the physical parameters of the transmitter signal and any components and combination thereof suitable for achieving fine adjustments of the OCS is contemplated.

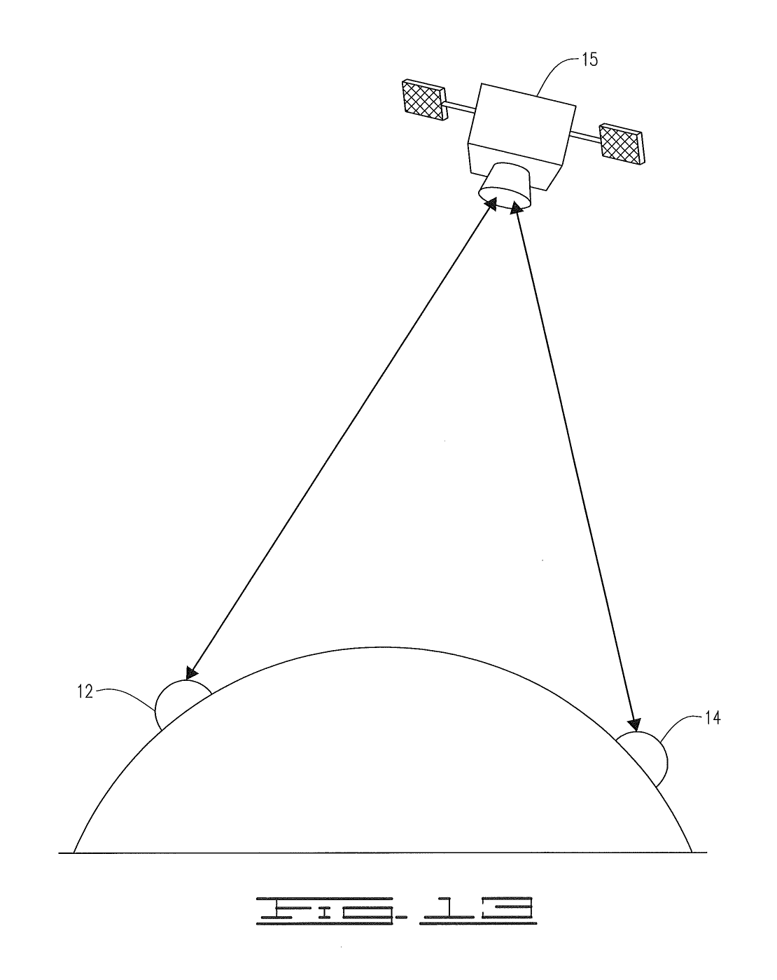

Starting, at Phase A System Start 300 and referring to FIGS. 13 and 18a, a notional example using global positioning satellites (GPS) is used to illustrate two nodes not having a direct line of sight. At block 302, location data is collected for determination of separation distance L between transmitter 22 in origination node 14 and receiver 24 access node 12 (or relay node 15). The separation distance L is calculated at block 304 with the information collected in block 302. At 306, optimal distance 74 between fiber optic cable 48 and collecting lens 46 at transmitter 22 is selected. The selected optimal distance 74 will optimize the value of W_{L} at the receiver. A person having skill in the art is aware of the relationship between Z_{fl} and W_{L}. Therefore, this relationship will not be discussed further herein. Also at 306, the optimal distance 100 between the fiber optic cable 96 and collecting lens 46 at receiver 22 is selected. The selected optimal distance 100 optimizes the strongest signal from transmitter 22. The likelihood of a successful connection is based on the value of separation distance L, the quality and layout of the particular design of transmitter 22, PAT system 86, and external environmental factors. At 308, the OCS waits for the BCS to settle for a predetermined amount of time. The predetermined amount of time will vary with the system application. This time to settle allows the OCS to avoid attempting to perform operations outside the scope of OCS capabilities, e.g. attempting to resolve large-scale pointing errors that are continually varying. By allowing the BCS to settle, the pointing errors will stabilize, and the OCS can adjust the transmitter parameters to accommodate for the errors.

After the BCS has settled, the protocol continues to Phase B, finer correction 400. Phase B includes detection lens 34 and quadrant detector 32 to make finer corrections in the alignment. In other embodiments, collecting lens 76 and PAT system 86 are used for finer corrections in the alignment. At 402, data, such as the magnitude and direction of error as interpreted by quadrant detector 32 is obtained, e.g. the data regarding the misalignment between the two transceivers along the x, y, and/or z directions. This functionality is performed for both nodes in the link 120 with each node acting based own its own information. For reference with this example, the plane of movement parallel to the ground is considered the x-y plane, and the direction perpendicular to the ground is the z-axis. At 404, the errors, Δx, Δy and Δz, for the x, y, and z directions, respectively, are calculated and fed to the appropriate controllers, for example the BCS and OCS. The balloon adjustment is limited by the control components. For the purposes of this non-limiting example, movement is possible only within the x-y plane, thus, only the Δx and Δy data is needed for the BCS.

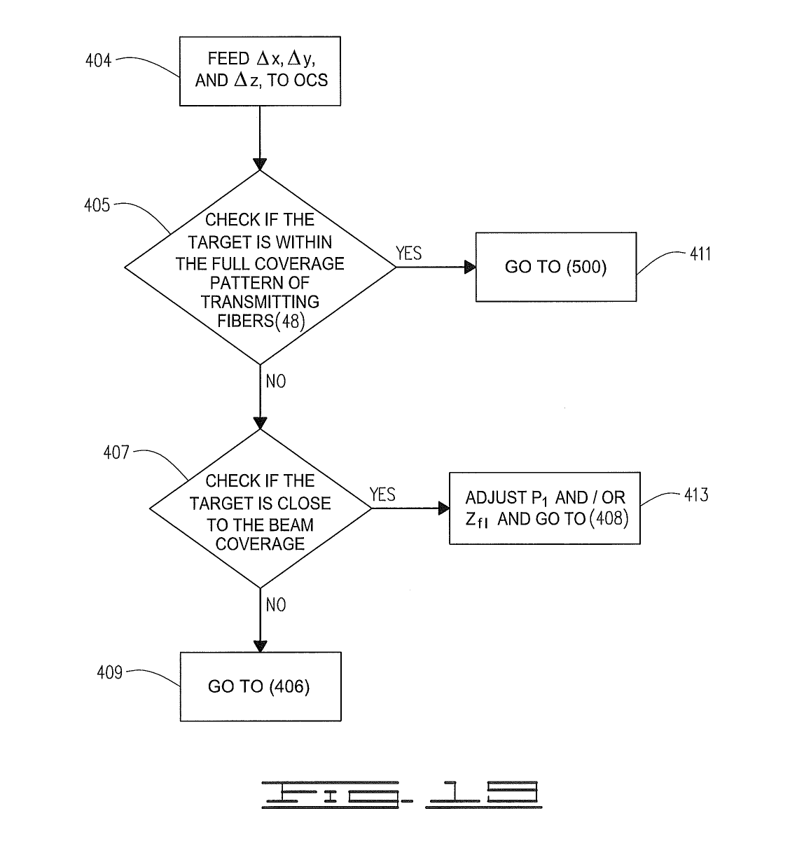

For purposes of this example, the OCS has the ability to make adjustments in all directions, thus Δx, Δy and Δz information is needed for the OCS. FIGS. 19-21 discuss variations of steps taken once information is provided to BCS and OCS at 404 for different embodiments. After the two control systems determine whether control actions will be executed by the respective system, a decision regarding control action is taken at 406. To determine which control system should take action, control boundaries are constructed that divide the control space. Two factors determine these control space boundaries: the dynamic range of the optical transmitter (switching angle, optical power, and optical divergence); and, foreknowledge of which actions are potentially beneficial and which actions are self-defeating.

At block 406, if the error calculation (within block 404) indicates that the corrective action required is outside the capabilities of the OCS, then the BCS is directed to act in an effort to achieve a better initial alignment condition. If the error calculation indicates that the corrective action is within the capabilities of the OCS, then action is requested of that system. If none of these changes can lead to a likely recovery of the link, then a gross adjustment of the orientation of the receiver is made by the BCS at 408. New errors Δx, Δy and Δz, are checked, if the new errors are within the capabilities of the OCS, then the OCS will provide further compensation for those errors. If the determination at block 408 is in the negative, the protocol loops back to block 402. If the determination at 408 is in the affirmative, the protocol continues to Phase C 500.

The corrective actions that can be taken by the control systems in block 406 are dependent on the composition of the switch network 180. If the switch network 180 is comprised of only optical splitters 66, also referred to as couplers, as depicted in FIG. 23, then the only actions that can be taken by the OCS are to change the optical power and divergence of signal beam 61, otherwise the BCS changes the orientation of the transceiver 20. FIG. 19 depicts a flow chart where switch network 180 is comprised only of optical splitters 66. A schematic representation of switch network 180 composed of only optical splitters 66 is illustrated in FIG. 23.

As shown in FIG. 19, information concerning the errors is provided to the OCS in block 404. At block 405, a determination is made as to whether or not the target (second receiver) is within the full coverage pattern. The full coverage pattern includes the entire area at the second receiver illuminated by the beam 61; where the combined outputs of all transmit fibers 48 within bundle 52 have sufficient power to complete link 120. If the determination is in the affirmative, the protocol goes to Phase C 500. If the determination of block 405 is in the negative, the protocol proceeds to block 407 to check if the target is close to beam coverage of beam 61. Close to beam coverage includes the target lies just outside the current full coverage area as described above. If the determination of block 407 is negative, the protocol is directed to block 406. If the determination of block 407 is in the affirmative, adjustments of P₁ and/or Z_{fl} 74 is performed to effectively expand the coverage area to include the position of the second receiver, and the protocol goes to block 408.

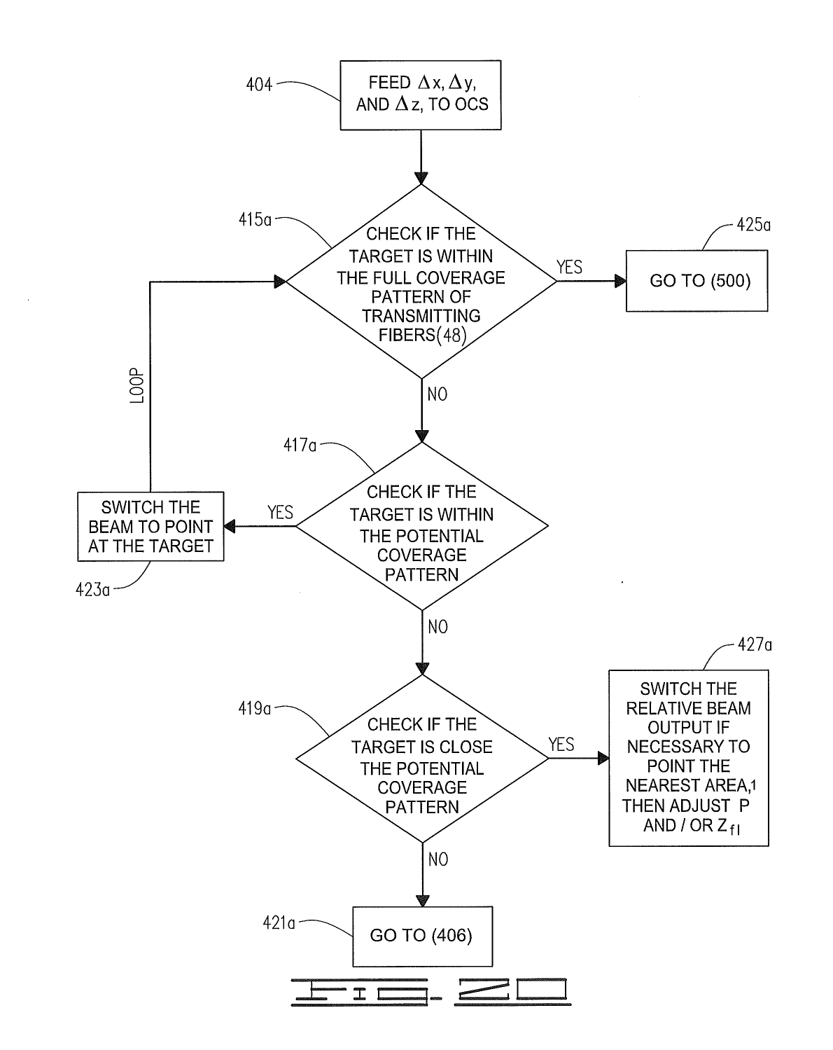

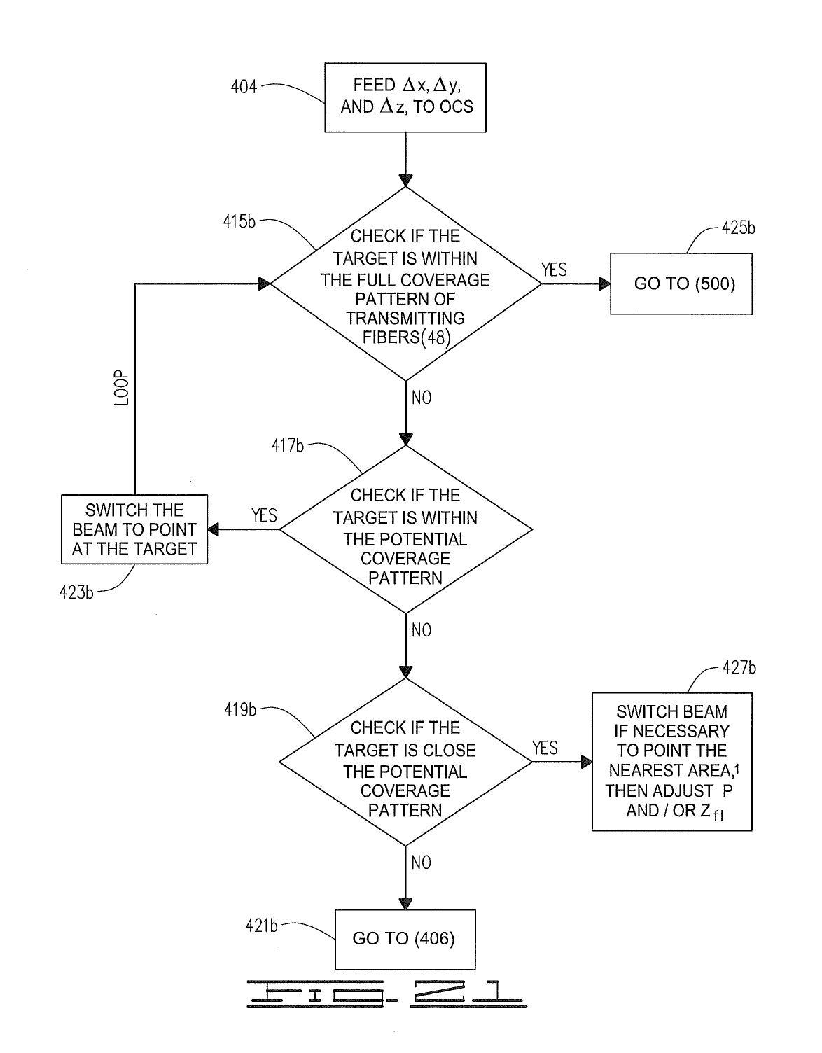

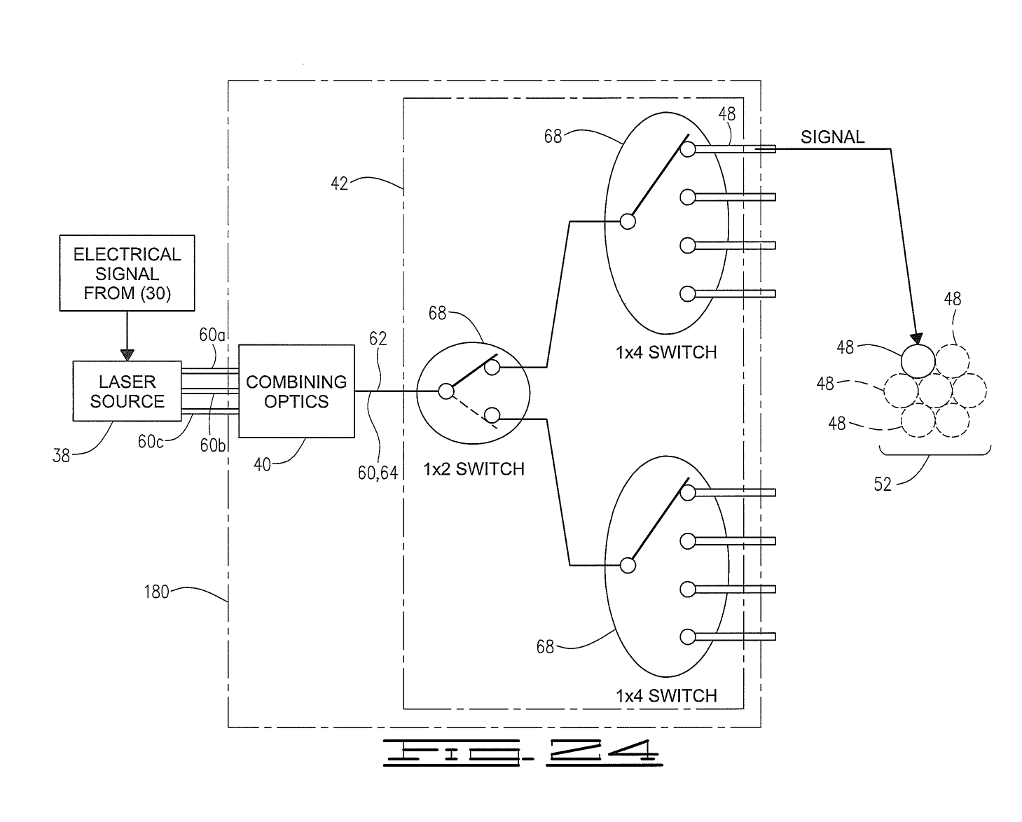

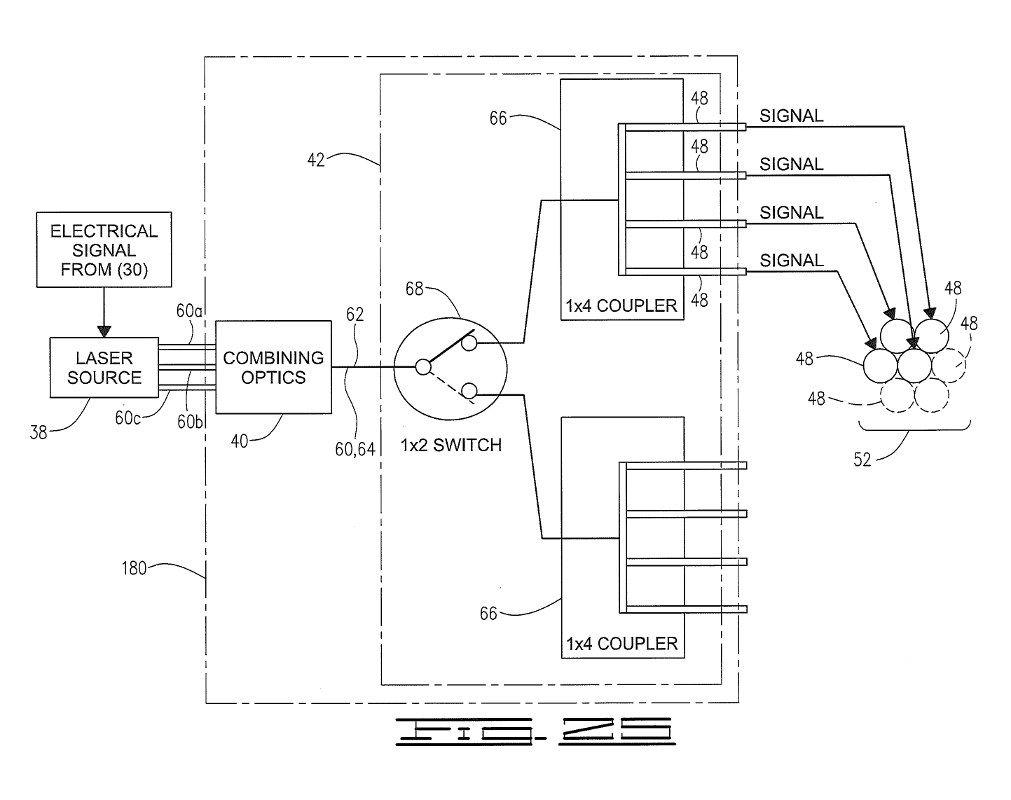

FIGS. 20 and 21 illustrate the steps taken when switch network 180 is composed of only switches 68 (FIG. 24), and when switch network 180 is composed of a combination of optical switches 68 and optical splitters 66 (FIG. 25), respectively. As shown in block 427a of FIG. 20, if the switch network 180 is comprised only of switches 68, then the OCS adjusts the optical power, beam divergence, and the source fiber 48 that is selected to communicate with the receiver 24. As depicted in block 427b of FIG. 21, if the switch network 180 is comprised of a combination of optical switches 68 and optical splitters 66, then the OCS adjusts the beam divergence, beam power, and source fiber(s) 48 that is selected to communicate with the receiver. For illustration purposes in FIGS. 23-25, fiber cable 48 having a solid circle is demonstrative of a selected transmit fiber cable 48 within fiber bundle 52 for communicating beam 61.

Referring to both FIGS. 20 and 21, blocks 415, 417, 419, 421, 423, and 425 are the same for the different embodiments of switch network 180. At blocks 415a and 415b, the process and control module 28, with input from either PAT system 86 or quadrant detector 32, assesses whether or not the target receiver is within the full coverage pattern of transmitting fibers 48. If yes, the protocol proceeds to block 500 as shown in block 425. If no, a determination is made as to whether the target is within the potential coverage pattern of another selection of transmitting fibers 48. In other words, processing and control module 28 calculates and determines whether the expected power distribution at the target resulting from illuminating another set of transmitting fibers 48 falls within this distribution. If the determination is in the affirmative at block 423, the switch network 180 directs beam 61 to point at the target. If the determination at block 417 is negative, a determination as to whether the target is close to potential coverage pattern occurs at block 419. If the determination of block 419 is in the negative, the protocol goes to block 406. If the determination of block 419 is in the affirmative, then the protocol proceeds to block 427. In FIG. 20 at 427a, processing and control module 28 sets switches 68, thereby adjusting the relative beam output 61, if necessary, to point to an area closest to the target. P₁ and/or Z_{fl} 74 is adjusted by laser source 38 and the divergence adjuster 50, respectively, to expand the coverage area to include the location of the targeted receiver at block 427a.

In FIG. 21 at block 427b when the determination of block 419 is in the affirmative, processing and control module 28 sets switches 68 of switch beam 61, if necessary, to point 61 to an area closest to the position of the target receiver. Adjustments are then made to P₁ and/or Z_{fl} 74 by laser source 38 and divergence adjuster 50, respectively, to expand the coverage area to include the location of the target receiver.

The corrective actions taken in each case also depend on data contained within the processing and control module 28 and information obtained from the channel estimator 84. The data contained within processing and control module 28 describes the range of transmitter power and beam divergence values that are available for use, and the number and arrangement of the transmitting fibers 48 that are available. If changes in these values are required that exceed the range available for use, then control is transferred from the OCS to the BCS for gross adjustment of the transceiver. As previously described, the channel estimator 84 provides information on the statistics of the channel that is used as an input in the decision on the changes in power, divergence and transmit fiber 48 selection required to establish an error-free connection.

Referring to FIG. 18b, illustrating Phase C, the control system checks whether a working communication link is established between the transmitter 22 and the receiver 24. If a signal is not present at receiver 24, then the system waits for predetermined amount of time at block 504. The predetermined amount of time includes time to allow for temporary interruption of the transmitting beam due to flying objects or other interference. If after the predetermined time no signal is present at the receiver 24, a report of the communication link failure is reported to the RF link at block 506. If a signal is present at the receiver 24 (block 502 or 504), and the link quality is acceptable (block 508), meaning the measured quantities meet or exceed the values required for error-free transmission, then the optical link is maintained as shown in block 514 and the steps in Phase B (400) are used to maintain the connection as the transceivers move.

If the BER, optical power, and OSNR do not meet the values required for error-free transmission at block 508, then a determination at block 510 is made to determine whether the values are sufficiently close to the required values such that correction by the OCS can improve the measured values. If the measured values are close to the required values, then corrective action is taken with the OCS as described in FIGS. 19-21 (block 516). After corrective action is taken, new values of BER, optical power and OSNR are measured and compared to the minimum required values. This process continues until either the minimum values are met or a predetermined time has passed. If the minimum values are not met in the predetermined time (block 512), then control action is passed back to the BCS and the control cycle begins again at block 402.

It should be appreciated that the threshold and/or qualified values are dependent upon the design choices made in selecting the electronic and optical components used within the nodes. Design choices will be determined based on the nature of the transmission handled by the link, for example military and/or emergency messages, including messages that can be resent repeatedly, or video and/or other high quality service transmissions.

A method of operating a mobile free-space optical network 10 is also disclosed. The method includes providing an access node 12 configured to bi-directionally send and receive optical communications. Access node 12 is in electronic communication with a network 16. A mobile origination node 14 is also provided. The mobile origination node 14 is configured to bi-directionally send and receive optical communications with at least one access node 12. The method further includes controlling an optical communication between the access node 12 and the mobile origination node 14 using a processing and control module 28. Both the access node 12 and the mobile origination node 14 each have a processing and control module 28.

The method also includes establishing the optical communication between the access node 12 and the mobile origination node 14. The access node 12 emits a beacon beam and/or signal beam having a wavelength and/or frequency suitable for being received by the mobile origination node 14. The mobile origination node 14 emits a beacon beam and/or signal beam having a wavelength and/or frequency suitable for being received by the access node 12. The method of operating a mobile FSO network 10 also includes aligning the optical communications between the access node 12 and the mobile origination node 14. Alignment of the optical communication between nodes requires transmission of a beam (beacon and/or signal) from access node 12 to mobile origination node 14. During transmission of beam, automated mechanized adjusters perform a gross adjustment of mobile origination node 14 sufficient to allow receipt of the beam at the mobile origination node and vice versa. Subsequently, processing and control module 28, in cooperation with other components finely adjust mobile origination node 14 and/or access node 12 to maximize signal strength of the transmitted signal beam. Fine adjustment is accomplished by detecting the signal power in quadrant detector 32 and/ PAT system 86. Alignment of the mobile FSO network 10 also provides for alignment between at least two mobile origination nodes 14.

There are multiple ways to locate and/or identify access node 12. For example, a search pattern is used to find the beacon signal of the access node 12. The search pattern includes at least a process of beam sweeping using a fiber optic cable bundle in the origination node 14. In another embodiment, access node 12 is identified by using known locations of the access node. Since access node 12 is at a fixed point, the known location of access node 12 may include, for example, a set of coordinates including longitude, latitude and height above sea level or a GPS defined location. These known locations are provided to mobile origination node 14 by RF signal(s). In another embodiment, the location of access node 12 is identified by using known locations of access node 12. The known locations are communicated to mobile origination node 14 by preloading the known locations of the access nodes 12 with global positioning information into the processing and control module 28 of the mobile origination node 14. In another embodiment, known locations of the access node 12 are communicated to the mobile origination node 14 by directly communicating with a database containing the known locations therein.

The method of operating mobile FSO network 10 also includes tracking the optical communication between access node 12 and the mobile origination node 14. The tracking provides continuous optical communication between mobile origination node 14 and access node 12. The optical communication between access node 12 and mobile origination node 14 is maintained using channel estimation described previously. The channel estimation system monitors localized weather data and estimates atmospheric conditions between access node 12 and the mobile origination node 14. At least one channel estimation algorithm is applied to a power-versus-time data of a guide beam 61, 72 to estimate a level of turbulence present in the atmosphere. Recall beam 72 may be propagated by either source 38 (thereby beams 61 and 72 are the same) or beacon 26 (separate source) for the embodiments described herein. This estimation includes measuring power loss due to an optical characteristic of absorption, scattering or turbulence. As a result, laser source 38 having a wavelength with the maximum power available at a receiver within the mobile origination node 14 and within the access node 12 is selected. In another embodiment, the method of operating mobile FSO network 10 also includes compensating for optical interference by monitoring the power of the optical communications and selecting a laser and wavelength best suited for transmission through the existing atmospheric conditions. The selection of the laser and wavelength is determined by the protocols described herein. Processing and control module 28 is capable of carrying out the necessary protocol(s).

In one embodiment, mobile origination node 14 is airborne and access node 12 is ground-based and the optical communication is transmitted therebetween. In another embodiment, relay node 15 is positioned between access node 12 and mobile origination node 14. Relay node 15 provides continuous optical communication between access node 12 and mobile origination node 14.

The method also includes summing an optical power output, wherein each access node 12 and each mobile origination node 14 have a receiver 24 with at least one optical lens 76 receiving an optical communication 61, 94. The optical lens communicates the optical communication to an optical fiber. The optical fiber communicates the optical communication to an optical combiner, and the optical combiner provides the optical output. The optical combiner includes lens 110 in lens array 108, aspheric lens 118 and detector 112. The power of the optical output is summed. Summation of the optical power output uses a first lens 110 to collimate the optical beam emitted by each optical fiber, and a second lens 118 to collect and condense the optical beam from each lens onto single photo detector 112; the second lens is an aspheric lens 118. Summing the optical power output also includes using a first detector to convert the summed signal into an electronic signal, at least a second detector to collect power for the processing and control module 28, and at least one of a third detector to collect power for the quadrant detector 32.

Other embodiments of the current invention will be apparent to those skilled in the art from a consideration of this specification or practice of the invention disclosed herein. Thus, the foregoing specification is considered merely exemplary of the current invention with the true scope thereof being defined by the following claims.

What is claimed is:

1. A free-space optical network comprising:
a network having a plurality of nodes;
at least one access node, the access node including a first transceiver capable of multi-angle, bi-directional line-of-sight optical communications, wherein the access node is in bi-directional electronic communication with the network;
at least one origination node, the origination node including a second transceiver, wherein the origination node is positioned within a line-of-sight of the access node, the origination node providing network connectivity for at least one end-user; and
a processing and control module configured to maintain line-of-sight optical communications between the access node and the origination node.

2. The free-space optical network of claim 1, wherein the first and second transceivers further comprise:
at least one transmitter;
at least one beacon associated with the transmitter; and
at least one receiver having at least one collecting optic and at least one fiber optic cable connected thereto, the collecting optic and fiber optic cable defining an optical communication path between the receiver and a optical processor, wherein the transmitter and receiver interactively provide the bi-directional communication for the first and second transceivers.

3. The free-space optical network of claim 2, wherein the transmitter further includes:
at least one transmitting laser;
at least one combining optic in optical communication with the transmitting laser;
a transmitter control system in optical communication with the combining optic;
a plurality of transmit fiber optics wherein the transmit fiber optics are in optical communication with the transmitter control system, wherein the transmitter control system communicates the transmitted laser power to one or more transmitting fiber optics using at least one power splitter and/or at least one switch; and
at least one transmitting lens defining a beam divergence of the transmitting laser.

4. The free-space optical network of claim 3, wherein the transmitter further includes a divergence adjuster providing mechanical positioning control of the transmitting lens and defining a magnitude of the beam divergence.

5. The free-space optical network of claim 3, further comprising a plurality of transmitting lasers.

6. The free-space optical network of claim 5, wherein a beam quality of the transmitting laser is affected by a weather condition and the transmitter control system is configured to switch between transmitting lasers in an adverse transmission condition.

7. The free-space optical network of claim 3, wherein a first transmitting laser has an infrared wavelength in the near infrared range from about 700 nanometers to about 1310 nanometers.

8. The free-space optical network of claim 7, wherein the infrared wavelength of the first transmitting laser is about 850 nanometers.

9. The free-space optical network of claim 3, wherein a second transmitting laser has an infrared wavelength in the near infrared range to the short-wavelength range which is from about 1310 nanometers to about 1550 nanometers.

10. The free-space optical network of claim 3, wherein a third transmitting laser has an infrared wavelength in the short-wavelength infrared range to the far infrared which is from about 1550 nanometers to about 1000 micrometers.

11. The free-space optical network of claim 10, wherein the third transmitting laser has an infrared wavelength in the range of about 2 micrometers to about 10.6 micrometers.

12. The free-space optical network of claim 2, wherein the beacon is a laser and defines an initial optical communications link between the originating node and the access node.

13. The free-space optical network of claim 2, further comprising a plurality of receivers having an optical processor capable of receiving optical communications, wherein the optical processor is capable of summing the plurality of optical communications from the plurality of receivers, wherein each receiver includes:
at least one collecting lens defining an entry point for at least one wavelength from the electromagnetic spectrum;
at least one fiber optic cable in optical communication with the collecting lens;
a divergence adjuster for adjusting a distance between the collecting lens and the fiber optic cable;
the optical processer in optical communication with the fiber optic cable, wherein the optical processer converts the wavelength into an electrical communications signal; and
a plurality of communications cables connected to and in electronic communications with the optical processor.

14. The free-space optical network of claim 2, wherein the receiver further comprises:
at least one collecting lens defining an entry point for at least one wavelength from the electromagnetic spectrum;
at least one fiber optic cable in optical communication with the collecting lens, wherein the collecting lens and the fiber optic cable are within a single transceiver;
a divergence adjuster for adjusting a distance between the collecting lens and the fiber optic cable;
the optical processer in optical communication with the fiber optic cable, wherein the optical processer converts the wavelength into an electrical communications signal; and
a communications cable connected to and in electronic communications with the optical processor.

15. The free-space optical network of claim 14, wherein the receiver, each associated collecting lens and each fiber optic cable providing optical communication with the collecting lens are within a single transceiver.

16. The free-space optical network of claim 14, wherein the receiver further comprises:
a photo detector; and
an optical splitting component, the optical splitting component being positioned in the optical communication path, wherein the optical splitting component redirects a small portion of the power in the wavelength to the photo detector.

17. The free-space optical network of claim 16, wherein the photo detector is in electronic communication with the processing and control module, the processing and control module providing power monitoring thereof.

18. The free-space optical network of claim 14, wherein the receiver further comprises:
a photo detector;
a plurality of fiber optic cables, wherein at least one fiber optic cable is dedicated to provide optical communication of a portion of the wavelength to the photo detector.

19. The free-space optical network of claim 14, wherein each transceiver further comprises:
a quadrant detector in electronic communication with a processing and control module;
a lens in optical communication with the quadrant detector; and
a guide beam.

20. The free-space optical network of claim 14, wherein each transceiver further comprises:
at least four photo detectors in electronic communication with the processing and control module; and
at least one of at least four fiber optic cables is dedicated to receive the wavelength in each of the cardinal directions, wherein the cardinal directions define the directions of up, down, left and right, wherein each of the fiber optic cables are in optical communication with a corresponding photo detector.

21. The free-space optical network of claim 1, wherein the origination node is a mobile node.

22. The free-space optical network of claim 1, further comprising at least one relay node positioned between the origination node and the access node, wherein the origination node is a mobile node and the relay node has at least one intermediate transceiver, the intermediate transceiver including a plurality of transmitters and receivers configured to provide optical communication between the origination node and the access node.

23. The free-space optical network of claim 22, wherein the relay node includes:
at least two transmitters each having at least two beacons associated therewith; and
at least two receivers each having at least one collecting optic and at least one fiber optic cable connected thereto, the collecting optic and fiber optic cable defining an optical communication path between the receiver and an optical processor, wherein the transmitter and receiver define the bi-directional relay communication between the first and second transceivers.

24. The free-space optical network of claim 1, wherein the first and second transceivers are each secured by a motorized mount, wherein the motorized mount is in electronic communication with the processing and control module.

25. The free-space optical network of claim 1, further comprising a first protocol defining the alignment and re-alignment of the transceivers.

26. The free-space optical network of claim 1, further comprising a second protocol providing multiple origination node connectivity wherein a plurality of origination nodes have at least one end-user connected thereto.

27. The free-space optical network of claim 1, further comprising a third protocol defining the selection of a wavelength for communicating between transceivers.

28. The free-space optical network of claim 1, further comprising a pointing, acquisition and tracking system electronically controlled by the processing and control module and configured to detect a beacon signal from the transceiver, and initiate and move the transceiver thereby orienting the beacon signal to maximize optical communication between transceivers and to maintain the line-of-sight.

29. A mobile free-space optical network comprising:
a network having a plurality of nodes;
at least one access node, the access node including a first transceiver capable of multi-angle, bi-directional line-of-sight optical communications, wherein the access node is in bi-directional electronic communication with the network;
at least one mobile origination node, the mobile origination node including a second transceiver, wherein the mobile origination node is positioned within a line-of-sight of at least one access node;
a processing and control module capable of maintaining line-of-sight optical communications between the access node and the mobile origination node; and
a pointing, acquisition and tracking system electronically controlled by the processing and control module and capable of detecting a beacon signal from the transceiver, initiate and reorient the transceiver to maximize optical communication between transceivers and to maintain the line-of-sight therebetween.

30. The mobile free-space optical network of claim 29, wherein the first and second transceivers include:
at least one transmitter;
at least one beacon associated with the transmitter; and
at least one receiver having at least one collecting optic and at least one fiber optic cable connected thereto, the collecting optic and fiber optic cable defining an optical communication path between the receiver and a optical processor, wherein the transmitter and receiver define the bi-directional communication for the first and second transceivers.

31. The mobile free-space optical network of claim 30, further comprising a plurality of access nodes having a continuity of optical communication from the origination node therebetween, wherein the processing and control module defines a coordinated handoff of the optical communication between each collecting optic, thereby providing for the continuity of optical communications.

32. The mobile free-space optical network of claim 30, wherein the transmitter further includes:
at least one transmitting laser;
at least one combining optic in optical communication with the transmitting laser;
a transmitter control system in optical communication with the combining optic;
a plurality of fiber optics, wherein the fiber optics are in optical communication with the transmitter control system, wherein the transmitter control system defines the transmitted laser power to one or more fiber optics using at least one power splitter and/or at least one switch; and
a divergence adjuster providing mechanical positioning control of the transmitting lens and defining a magnitude of a beam divergence; and
at least one transmitting lens defining the beam divergence of the transmitting laser.

33. The mobile free-space optical network of claim 32, further comprising a plurality of transmitting lasers.

34. The mobile free-space optical network of claim 32, wherein a beam quality of the transmitting laser is affected by a weather condition and the transmitter control system is configured to switch between transmitting lasers in an adverse transmission condition.

35. The mobile free-space optical network of claim 32, wherein a first transmitting laser has an infrared wavelength in the near infrared range from about 700 nanometers to about 1310 nanometers.

36. The mobile free-space optical network of claim 35, wherein the infrared wavelength of the first transmitting laser is about 850 nanometers.

37. The mobile free-space optical network of claim 32, wherein a second transmitting laser has an infrared wavelength in the near infrared range to the short-wavelength range which is from about 1310 nanometers to about 1550 nanometers.

38. The mobile free-space optical network of claim 32, wherein a third transmitting laser has an infrared wavelength in the short-wavelength infrared range to the far infrared which is from about 1550 nanometers to about 1000 micrometers.

39. The mobile free-space optical network of claim 38, wherein the third transmitting laser has an infrared wavelength in the range of about 2 micrometers to about 10.6 micrometers.

40. The mobile free-space optical network of claim 30, wherein the beacon is a laser and defines an initial optical communications link between the originating node and the access node.

41. The free-space optical network of claim 30, further comprising a plurality of receivers having an optical processor capable of receiving electronic communications, wherein the optical processor is capable of summing the plurality of electronic communications from the plurality of receivers, wherein each receiver includes:
at least one collecting lens defining an entry point for at least one wavelength from the electromagnetic spectrum;
at least one fiber optic cable in optical communication with the collecting lens;
a divergence adjuster for adjusting a distance between the collecting lens and the fiber optic cable;
the optical processer in optical communication with the fiber optic cable, wherein the optical processer converts the wavelength into an electrical communications signal; and
a plurality of communications cables connected to and in electronic communications with the optical processor.

42. The mobile free-space optical network of claim 30, wherein the receiver further comprises:
at least one collecting lens defining an entry point for at least one wavelength from the electromagnetic spectrum;
at least one fiber optic cable in optical communication with the collecting lens, wherein the collecting lens and the fiber optic cable are within a single transceiver;
a divergence adjuster for adjusting a distance between the collecting lens and the fiber optic cable;
the optical processer in optical communication with the fiber optic cable, wherein the optical processer converts the wavelength into an electrical communications signal; and
a communications cable connected to and in electronic communications with the optical processor.

43. The mobile free-space optical network of claim 42, wherein the receiver, each associated collecting lens and each fiber optic cable providing optical communication with the collecting lens are within a single transceiver.

44. The mobile free-space optical network of claim 42, wherein the receiver further comprises:
a photo detector; and
an optical splitting component, the optical splitting component being positioned in the optical communication path, wherein the optical splitting component redirects a portion of the power in the wavelength to the photo detector.

45. The mobile free-space optical network of claim 44, wherein the photo detector is in electronic communication with the processing and control module, the processing and control module providing power monitoring thereof.

46. The mobile free-space optical network of claim 42, wherein the receiver further comprises:
a photo detector;
a plurality of fiber optic cables, wherein at least one fiber optic cable is dedicated to provide optical communication of a portion of the wavelength to the photo detector.

47. The mobile free-space optical network of claim 42, wherein each transceiver further comprises:
a quadrant detector in electronic communication with the processing and control module;
a lens in optical communication with the quadrant detector; and
a guide beam.

48. The mobile free-space optical network of claim 42, wherein each transceiver further comprises:
at least four photo detectors in electronic communication with the processing and control module; and
at least one of at least four fiber optic cables is dedicated to receive the wavelength in each of the cardinal directions, wherein the cardinal directions define the directions of up, down, left and right, wherein each of the fiber optic cables are in optical communication with a corresponding photo detector.

49. The mobile free-space optical network of claim 29, wherein the origination node is a mobile node.

50. The mobile free-space optical network of claim 29, further comprising at least one relay node positioned between the origination node and the access node, wherein the origination node is a mobile node and the relay node has at least one intermediate transceiver, the intermediate transceiver including a plurality of transmitters and receivers capable of providing optical communication between the origination node and the access node.

51. The mobile free-space optical network of claim 50, wherein the relay node includes:
at least two transmitters each having at least two beacons associated therewith; and
at least two receivers each having at least one collecting optic and at least one fiber optic cable connected thereto, the collecting optic and fiber optic cable defining an optical communication path between the receiver and a communications processor, wherein the transmitter and receiver define the bi-directional relay communication between the first and second transceivers.

52. The mobile free-space optical network of claim 29, wherein the first and second transceivers are each secured by a motorized mount, wherein the motorized mount is in electronic communication with the processing and control module.

53. The mobile free-space optical network of claim 29, further comprising a first protocol defining the alignment and re-alignment of the transceivers.

54. The mobile free-space optical network of claim 29, further comprising a second protocol providing multiple origination node connectivity wherein a plurality of origination nodes have at least one end-user connected thereto.

55. The mobile free-space optical network of claim 29, further comprising a third protocol defining the selection of a wavelength for communicating between transceivers.

56. The mobile free-space optical network of claim 29, wherein the access node and the mobile origination node are configured to search for the beacon signal to locate the other node.

57. The mobile free-space optical network of claim 56, wherein the mobile origination node is the unit configured to search for the beacon signal to locate the access node.

58. The mobile free-space optical network of claim 57, wherein the processing and control module is capable of providing fine adjustments to alignment between access node and the mobile origination node.

59. The mobile free-space optical network of claim 58, wherein the fine adjustment is defined by detecting beacon signal power in a quadrant detector, the processing and control module is configured to provide inputs to align the optics of the access node and the mobile origination node to increase beacon signal power thereon.

60. The mobile free-space optical network of claim 59, wherein the processing and control module is capable of providing adjustment of the mobile origination node and the access node, and providing line-of-sight corrections thereto based upon the continuous monitoring of the power from the beacon signal.

61. A method of operating a mobile free-space optical network comprising:
providing an access node, the access node capable of bi-directionally sending and receiving optical communications, wherein the access node is in electronic communication with a network;
providing a mobile origination node, the mobile origination node capable of bi-directionally sending and receiving optical communications with at least one access node; and
controlling an optical communication between the access node and the mobile origination node using a processing and control module, wherein the access node and the mobile origination node each have a processing and control module therein.

62. The method of claim 61, further comprising the step of establishing the optical communication between the access node and the mobile origination node, wherein the access node emits a beacon that is receivable by the mobile origination node, and the mobile origination node emits a beacon that is receivable by the access node.

63. The method of claim 62, further comprising the step of aligning the optical communications between the access node and the mobile origination node.

64. The method of claim 63, wherein the step of aligning includes:
emitting a beacon from the access node and the mobile origination node;
grossly adjusting the mobile origination node to receive the emitted beacon from the access node; and
finely adjusting the mobile origination node, wherein the fine adjustment is accomplished using the processing and control module, the processing and control module using a quadrant detector and a signal power input to make the fine adjustments to the alignment between the mobile origination node and the access node.

65. The method of claim 64, further comprising the step of using automated mechanized adjusters to grossly adjust the mobile origination node.

66. The method of claim 65, further comprising the step of aligning between at least two mobile origination nodes.

67. The method of claim 63, further comprising the step of using a search pattern to find the beacon signal of the access node, wherein the search pattern includes at least a process of beam sweeping using a fiber optic cable bundle in the mobile origination node.

68. The method of claim 62, further comprising the step of identifying a location of the access node by using known locations thereof, wherein the known locations are communicated to the mobile origination node by a radio frequency signal.

69. The method of claim 62, further comprising the step of identifying a location of the access node by using known locations thereof, wherein the known locations are communicated to the mobile origination node by preloading the locations of the access nodes with global positioning information into the processing and control module of the mobile origination node.

70. The method of claim 62, further comprising the step of identifying a location of the access node by using known locations thereof, wherein the known locations are communicated to the mobile origination node by directly communicating with a database having the known locations.

71. The method of claim 61, further comprising the step of tracking the optical communication between the access node and the mobile origination node, wherein the tracking includes providing continuous optical communication between the mobile origination node and the access node.

72. The method of claim 61, wherein the mobile origination node is airborne and the access node is ground-based with the optical communication transmitting therebetween.

73. The method of claim 61, further comprising a relay node positioned between the access node and the mobile origination node providing continuous optical communication therebetween.

74. The method of claim 61, further comprising the step of compensating for optical interference including:
monitoring the power of the optical communications; and
selecting a laser and wavelength best suited for transmission through the existing atmospheric conditions, wherein selecting is determined by a protocol operated by the processing and control module.

75. The method of claim 61, further comprising the step of maintaining the optical communication between the access node and the mobile origination node using channel estimation, wherein the channel estimation monitors localized weather data and estimates atmospheric conditions between the access node and the mobile origination node.

76. The method of claim 75, wherein at least one channel estimation algorithm is applied to a power-versus-time data of a guide beam to estimate a level of turbulence present in the atmosphere.

77. The method of claim 76, wherein the estimating includes measuring power loss due to an optical characteristic of absorption, scattering or turbulence.

78. The method of claim 75, further comprising selecting a laser having a wavelength with the maximum power available at a receiver within the mobile origination node and within the access node.

79. The method of claim 61, further comprising the step of summing an optical power output, wherein each access node and each mobile origination node have a receiver with at least one optical lens receiving an optical communication, the optical lens communicating the optical communication to an optical fiber, the optical fiber communicating the optical communication to an optical combiner, the optical combiner providing the optical output.

80. The method of claim 79, wherein the step of summing the optical power output uses a first lens to collimate the optical beam emitted by each optical fiber, and a second lens to collect and condense the optical beam from each lens onto single photo detector, wherein the second lens is an aspheric lens.

81. The method of claim 79, wherein the step of summing the optical power output uses a first detector to convert the summed signal into an electronic signal, at least a second detector to collect power for the processing and control module, and at least one of a third detector to collect power for the quadrant detector.
